(19) United States
(12) Patent Application Publication
(10) Pub. No.: US 2025/0171355 A1
(43) Pub. Date: May 29, 2025

(54) PROCESS FOR DECARBONATION OF CARBONATED MATERIALS AND HYDRATION THEREOF AND DEVICE THEREOF

(71) Applicant: CARMEUSE TECHNOLOGIES, Louvain-la-Neuve (BE)

(72) Inventors: Charles ROBIN, Faulx-Les-Tombes (BE); Steven Bruce GUTHRIE, Malonne (BE); Pierre-Olivier CAMBIER, Hamme-Mille (BE); Johan BRANDT, Nandrin (BE)

(21) Appl. No.: 18/842,662

(22) PCT Filed: Feb. 23, 2023
(86) PCT No.: PCT/EP2023/054598

§ 371 Date: Aug. 29, 2024

(30) Foreign Application Priority Data
Mar. 2, 2022 (EP) 22159664.6

(51) Int. Cl. C04B 7/51; B01J 8/18; C04B 7/44; C04B 7/47

(52) U.S. Cl. CPC C04B 7/51; B01J 8/1827; B01J 8/1836; C04B 7/44; C04B 7/475; B01J 2208/00176

(57) ABSTRACT

A process is disclosed for decarbonation of limestone, dolomite or other carbonated materials and hydration of decarbonated limestone, dolomite or other carbonated materials. The process may include: heating particles of carbonated materials in a reactor of a first circuit; conveying the particles of carbonated materials by a first entraining gas; transferring the decarbonated particles to a second circuit, in which a second gas circulates, the circuit including a hydration section; hydrating the decarbonated particles; and transferring at least a portion of the heat generated by the hydration of the decarbonated particles to the second gas being substantially free of carbon dioxide;. The first and second circuits are separated by first selective separation means allowing the passage of solids while substantially preventing the passage of the gases.

### FIELD

The present disclosure relates to a process for decarbonation of limestone, dolomite or other carbonate (d) materials and hydration of said decarbonated limestone, dolomite or other carbonate (d) materials and a device thereof.

### BACKGROUND

Traditionally, the decarbonation of limestone or dolomite is performed through calcination in a kiln.

The traditional kilns reject significant amounts of CO₂ via the decarbonation of the carbonated materials and the combustion of fuels. In the search for cleaner industrial plants and cost saving in emerging markets that penalize carbon emissions, efforts have been made to reduce the CO₂ footprint of kilns by introducing heat-regeneration measures. For instance, the air that is heated from product cooling is blown into the burning zone of the kiln and used for the combustion of the fuel. These improvements are required to achieve an efficiency with a specific heat input of <5.2 GJ/Tonne product. However, the CO₂ generated in the known kilns is still emitted to the atmosphere as it cannot be used or sequestered because it is too diluted in the flue gas.

To overcome these drawbacks, the skilled person has come along with the concept of a calciner as that disclosed in U.S. Pat. No. 4,707,350, where limestone particles are entrained/conveyed by CO₂ gas in a close-loop circuit. The carbonated particles are first preheated before they are fed into a reactor where the decarbonation takes place under high temperatures. This known process overcomes most of the known drawbacks. The decarbonation takes place in an atmosphere that is substantially free of nitrogen. The generated CO₂ can be used or sequestered. However, the extended residence time of decarbonated particles in a CO₂-rich atmosphere in a cooling zone positioned downstream from the decarbonation reactor causes recarbonation of the product (i.e. lime).

Patent EP 2230223 B1 discloses a kiln comprising chambers, where a first chamber is dedicated to the decarbonation with an atmosphere that is free of nitrogen and a second chamber dedicated to the cooling of the decarbonated particles in an atmosphere that is free of CO₂ in order to limit the exposure of the product (i.e. lime) to CO₂. This process further teaches a solution to recover energy. This kiln (a.k.a. shaft kiln) presents a static technology, where pebbles are stacked in the chambers.

The kiln of EP 2230223 B1 is conceived to be operated with pebbles, for which it is difficult in practice to have a proper sealing device without introducing a complex locking mechanism between both chambers. Moreover, this kiln does not offer the possibility to optimise the operation of limestone quarries. Indeed, the fines that are generated during the crushing operations required to produce the pebbles are generally hardly used in such a kiln. Finally, the maximal throughput is typically around 500 to 600 t/day and this level is comparatively low to reach scale economies.

Patent application EP 3221264 A1 teaches a process for producing a highly calcined and uniformly calcined product in a flash calciner, where the decarbonation fine carbonated materials takes place in a few seconds. However, this publication fails to disclose any measure on how to operate two separated circuits, namely a calcination and a cooling circuit, in which circulate two different gases (one rich in CO₂ and the second free of CO₂) for conveying the particles of carbonate/decarbonated materials and fails to achieve the desired products of cooled pure CO₂ and decarbonated material from the carbonated material.

Furthermore, the decarbonated of limestone or dolomite can be hydrated to form hydroxides (comprising Ca(OH)₂ and/or Mg(OH)₂). This process generate substantial amount of heat that is generally not recovered.

### SUMMARY

The present disclosure aims to provide a solution to at least one drawback of the teaching provided by the prior art.

More specifically, the present disclosure aims to provide a process and a device for allowing a decarbonation and hydration with a high production throughput of a product (e.g. hydrated lime) while producing a CO₂ rich stream suitable for sequestration or use and recovering, at least partly, the heat generated by the hydration reaction.

For the above purpose, the present disclosure is directed to a process for decarbonation of limestone, dolomite or other carbonated materials and hydration of said decarbonated limestone, dolomite or other carbonated materials, said process comprising the following steps:
heating particles of carbonated materials in a reactor of a first circuit up to a temperature range in which carbon dioxide of the carbonated materials is released to obtain decarbonated particles comprising CaO and/or MgO;
optionally conveying said particles of carbonated materials by a first entraining gas in the first circuit for preheating said carbonated materials, said gas comprising the released carbon dioxide, said gas composition being substantially free of nitrogen;
optionally separating, in particular inertially separating, the carbonated particles from a first entraining gas flow;
transferring the decarbonated particles to a second circuit, in which a second gas circulates, said circuit comprising a hydration section;

cooling the decarbonated particles in a cooling section of the second circuit, in which the decarbonated particles release a portion of their thermal energy, thereby heating the second gas and ensuring a cooling of said decarbonated particles;
hydrating the decarbonated particles in contact with water as liquid and/or steam, and optionally in the presence of a dilution gas, such as air or a dioxygen enriched composition, in particular pure dioxygen, in the hydration section to obtain hydrated particles comprising Ca(OH)₂ and/or Mg(OH)₂;
transferring at least a portion of the heat generated by the hydration of the decarbonated particles to the second gas;
wherein the first and second circuits are separated by a first selective separation means allowing the passage of solids while substantially preventing the passage of the gases, wherein said second gas is substantially free of carbon dioxide.

According to specific embodiments of the present disclosure, the process comprises one or more of the following technical features:
the cooling section of the second circuit is positioned downstream from the hydration section, further comprising before the hydration step:
   separating, in particular inertially separating, the decarbonated particles conveyed by a second gas flow in the cooling section;
   transferring the separated decarbonated particles from the cooling section to the hydration section.
a portion of the heat generated by at least the hydration of the decarbonated particles, the sensible heat of the decarbonated particles and/or the sensible heat of the hydrated particles, are transferred to a third gas substantially free of carbon dioxide circulating in a third circuit, in particular via a heat exchanger or via contacting the hydrated particles and/or decarbonated particles with the third gas, respectively.
transferring the separated decarbonated particles to a cooling section of the third circuit comprising the third gas in which the conveyed decarbonated particles release a portion of their thermal energy, in particular via a first selective separation means arranged between the second and third circuits, said separation means allowing the passage of solids while substantially preventing the passage of the gases.
separating the decarbonated particles from a third gas flow;
transferring the decarbonated particles separated from the third gas flow to the hydration section, in particular via a second selective separation means arranged between the second and third circuits, said separation means allowing the passage of solids while substantially preventing the passage of the gases.
transferring the hydrated particles to a further cooling section in the third circuit in which the hydrated particles release a portion of their thermal energy, preferably via a third selective separation means arranged between the second and third circuits, said separation means allowing the passage of solids while substantially preventing the passage of the gases;
separating the hydrated particles cooled in the previous step from the third gas flow, wherein the further cooling section is arranged upstream from the cooling section of the third circuit.
transferring the hydrated particles to a further cooling section of the second circuit upstream from the hydration section, in which the conveyed hydrated particles release a portion of their thermal energy, thereby heating the second gas flow.
Feeding the hydration section with
   the decarbonated particles,
   liquid water and/or water steam, and
   optionally the diluting gas;
Extracting a gas comprising hot air, water steam, fuel, or a dioxygen enriched composition, or any mixture thereof from said hydration section, said gas comprising at least a portion of the heat generated by the hydration of the decarbonated particles;
Feeding the second circuit with said gas.
transferring at least a portion of the heat generated by the hydration of the decarbonated particles to the second gas comprises transferring at least a portion of the heat generated by the hydration of the decarbonated particles to the second gas via at least one heat exchanger.
the hydration section comprises a fluidized bed reactor such as a circulating fluidized bed, an entrained bed or a bubbling bed or a slaker such as a paddle mixer.
transferring the hydrated particles from the hydration section to a slaked lime dryer;
drying the hydrated particles in the slaked lime dryer using a portion of the thermal energy of the second fluid flow.
introducing the particles of carbonated materials in a heating section of the second circuit, in which the heating section is positioned downstream of the hydration section, so that the heat extracted from the hydration section, the decarbonated particles, and optionally the hydrated particles, in particular to the second gas, is used to heat the particles of carbonated materials by means of a solid-gas heat exchange, the heated carbonated particles being subsequently separated from the second gas flow and transferred to the reactor or upstream of a pre-heating section of the first circuit, preferably via a second selective separation means arranged between the first circuit and the second circuit, allowing the passage of solids while substantially preventing the passage of the gases.
introducing the particles of carbonated materials in a heating section of the third circuit, in which the heating section is positioned downstream of the cooling section, so that heat extracted from the decarbonated particles and optionally the hydrated particles and/or heat extracted from the hydration section, in particular to the third gas, is used to heat the particles of carbonated materials by means of a solid-gas heat exchange, the heated carbonated particles being subsequently separated from the third gas flow and transferred to the reactor or upstream of the pre-heating section of the first circuit, preferably via a selective separation means arranged between the first circuit and the third circuit, allowing the passage of solids while substantially preventing the passage of the gases.
maintaining pressure in at least the hydration section, the cooling section and/or the further cooling section of the second circuit above the atmospheric pressure between 1 and 20 bars above atmospheric pressure, and/or the temperature in at least the hydration section, the cooling section and/or the further cooling section of the second circuit below the temperature at which de-hydration occurs such as T[°K]<11607/(14,6484−ln (PH20[bar])).
feeding the second circuit with air and/or an dioxygen enriched composition, in particular pure dioxygen, and optionally fuel.
feeding the third circuit with air and/or an dioxygen enriched composition, in particular pure dioxygen, and optionally fuel.
feeding the reactor with the second and/or third gas.
discharging the second gas in the atmosphere, at an outlet of the second circuit.
discharging the third gas in the atmosphere, at an outlet of the third circuit.
supplying with the second and/or third gas at least one heat recovery element in which the heat of the second and/or third gas is used for:
   preheating and drying at least carbonated materials, in particular the carbonated particles and/or fuel;
   drying hydrated products, in particular the hydrated particles;
   providing heat source for a gas treatment process, in particular an amine gas treating apparatus, a thermal swing adsorption apparatus, a cryogenic refrigeration apparatus, a CO2 conversion reaction;
   generating mechanical work; and/or
   generating electricity.
introducing the particles of carbonated materials in the pre-heating section of the first circuit so that said particles are pre-heated by the first entraining gas by means of a solid-gas heat exchange.
recirculating at least a portion of the carbon dioxide released in the reactor in the first circuit, preferably recirculating said carbon dioxide to the reactor.
recycling at least a portion of the heat of the second gas, preferably exchanging heat from the second to the first entraining gas, more preferably through a gas-gas heat exchanger positioned between the first circuit and the second circuit.
recycling at least a portion of the heat of the third gas, preferably exchanging heat from the third gas to the first entraining gas, more preferably through a gas-gas heat exchanger positioned between the first circuit and third circuit.
at least one of the separation means allowing the passage of solids while substantially preventing the passage of the gases comprises a siphon element, a loop seal, single or multiple flaps, table feeder, cellular wheel sluice, fluid seal-pot, “Dollar” plate, or any of the following valves: rotary valves, cone valve, J valve, L valve, trickle valve and flapper valve.
the particles of the carbonated minerals have a d90 less than 10 mm, preferably less than 6 mm, more preferably less than 4 mm;
the carbon dioxide represents at least 50%, preferably at least 85% by volume of the first entraining dry gas composition exiting the reactor;
comprising the step of controlling a louver or a damper and/or a fan speed in at least the first circuit, second circuit and/or third circuit so that the absolute pressure difference across at least one of the selective separation means remains below a predefined value, preferably remains within a given pressure range.

For the above purpose, the present disclosure is also directed to a process for decarbonation of limestone, dolomite or other carbonated materials comprising steps of
producing hydrated particles using the process for decarbonation of limestone, dolomite or other carbonated materials and hydration of said decarbonated limestone, dolomite or other carbonated materials according to the present disclosure;
transferring the hydrated particles to a dehydrating section;
dehydrating the hydrated particles in the dehydrating section in which the hydrated particles are exposed to a temperature range and pressure range in which the H₂O is released forming further decarbonated particles comprising CaO and/or MgO.

According to specific embodiments of the present disclosure, the process comprises one or more of the following technical features:
the dehydrating section is provided in the third circuit downstream from the cooling section thereof,
transferring the hydrated particles from the hydration section to the dehydrating section, optionally via a fourth selective separation means arranged between the second and third circuits allowing the passage of solids, while substantially preventing the passage of the gases, said process further comprising the step of discharging the further decarbonated particles formed in the dehydrating section.
transferring the further decarbonated particles discharged to a complementary cooling section in the third circuit in which the further decarbonated particles release a portion of their thermal energy;
separating the further decarbonated particles cooled in the previous step from the third gas flow, wherein the complementary cooling section is arranged upstream from the cooling section of the third circuit.

For the above purpose, the present disclosure is also directed to a process for capturing CO2 from air or flue gas comprising the following steps:
a. producing hydrated materials using a process for decarbonation of limestone, dolomite or other carbonated materials and hydration of said decarbonated limestone, dolomite or other carbonated materials according to the present disclosure;
b. contacting the produced lime hydrate materials with CO2-containing gas stream such as air or flue gas so as to remove CO2 from said gas stream, respectively;
c. recycling the carbonated materials formed in step b) as carbonated materials for step a).

For the above purpose, the present disclosure is also directed to a process for capturing CO2 from air or flue gas comprising the following steps:
a. producing decarbonated materials using the process for decarbonation of limestone, dolomite or other carbonated materials according to the present disclosure;
b. contacting the produced decarbonated materials with air or flue gas so as to remove CO2 from air or flue gas, respectively;
c. recycling the carbonated materials formed in step b) as carbonated materials for step a).

The present disclosure also relates to a device for the decarbonation of limestone, dolomite or other carbonated materials and hydration of said decarbonated limestone, dolomite or other carbonated materials, for carrying out the process according to the present disclosure comprising:
a first circuit in which a first gas substantially free of nitrogen conveys particles of said carbonated mineral, said first circuit comprising a reactor in which said particles are heated to a temperature range in which carbon dioxide is released to obtain decarbonated particles comprising CaO and/or MgO;
a second circuit in which a second gas substantially free of carbon dioxide is circulated, the second circuit comprising cooling section for cooling the decarbonated particles transferred from the first circuit and a hydration section in which the decarbonated particles cooled are in contact with water as liquid and/or steam at least liquid water and/or water steam and optionally a diluting gas;
at least one selective separation means connecting the first and second circuits arranged so as to allow the transfer of either the particles of carbonated materials or the decarbonated particles of said materials between the first circuit and the second circuit while substantially preventing the passage of gases, in particular a siphon element, a loop seal, single or multiple flaps, table feeder, cellular wheel sluice, fluid seal-pot, “Dollar” plate, or any of the following valves: rotary valves, cone valve, J valve, L valve, trickle valve and flapper valve.

According to specific embodiments of the present disclosure, the device comprises one or more of the following features:
the cooling section of the second circuit is positioned downstream from the hydration section of the second circuit;
the second circuit comprises a further cooling section upstream from the hydration section.
the cooling section and optionally the further cooling section comprise(s) a solid/gas suspension heat exchanger, respectively;
a first selective separation means connecting the first and the second circuit allowing the transfer of the decarbonated particles from the first circuit to the second circuit while substantially preventing the passage of gases, the first selective separation means being connected upstream of an inlet of the suspension heat exchanger of the cooling section of the second circuit;
the hydrating section comprises a fluidized bed reactor such as a circulating fluidized bed, an entrained bed or a bubbling bed or a slaker such as a paddle mixer;
a third circuit in which a third gas substantially free of carbon dioxide is circulated, said circuit comprising a cooling section in which the decarbonated particles transferred from the second circuit release a portion of their thermal energy to the third gas, preferably said cooling section comprising a solid/gas suspension heat exchanger;
a first selective separation means connecting the second and the third circuit allowing the transfer of the decarbonated particles from the second circuit to the third circuit while substantially preventing the passage of gases, preferably the first selective separation means being connected to a return passage for collecting the separated decarbonated particles of the suspension heat exchanger of the cooling section of the second circuit and upstream of an inlet of the suspension heat exchanger of the cooling section of the third circuit;
the third circuit comprises a further cooling section positioned upstream from the cooling section of the third circuit, preferably said further cooling section comprising a solid/gas suspension heat exchanger;
a second selective separation means connecting the third and the second circuit allowing the transfer of the decarbonated particles from the third circuit to the second circuit while substantially preventing the passage of gases, preferably the second selective separation means being connected to a return passage for collecting the separated decarbonated particles of the suspension heat exchanger of the cooling section of the third circuit and to an inlet of the hydration section;
a third selective separation means connecting the second and the third circuit allowing the transfer of the hydrated particles from the second circuit to the third circuit while substantially preventing the passage of gases, preferably the third selective separation means being connected to an outlet of the hydration section and upstream of an inlet of the suspension heat exchanger of the further cooling section of the third circuit;
the first circuit comprises a pre-heating section, said pre-heating section comprising a solid/gas suspension heat exchanger;
the second circuit comprises a heating section positioned downstream from the cooling section of the second circuit, preferably said heating section comprising a solid/gas suspension heat exchanger;
a second selective separation means connecting the first and the second circuit allowing the transfer of the carbonated particles from the second circuit to the first circuit while substantially preventing the passage of gases, preferably the second selective separation means being connected to a return passage for collecting the separated carbonated particles of the solid/gas suspension heat exchanger of the heating section of the second circuit and to the reactor or upstream of the solid/gas suspension heat exchanger of the pre-heating section of the first circuit;
the third circuit comprises a heating section positioned downstream from the cooling section of the third circuit, preferably said heating section comprising a solid/gas suspension heat exchanger;
a second selective separation means connecting the first and the third circuit allowing the transfer of the carbonated particles from the third circuit to the first circuit while substantially preventing the passage of gases, preferably said selective separation means being connected to a return passage for collecting the separated carbonated particles of the solid/gas suspension heat exchanger of the third circuit and to the reactor or upstream of the solid/gas suspension heat exchanger of the pre-heating section of the first circuit;
the reactor comprises an externally-fired calciner, said externally-fired calciner comprising an exhaust passage, said passage being connected to the second circuit, preferably upstream of the heating section;
the solid/gas suspension heat exchanger of the first circuit comprises at least one inertial separator, in particular a cyclone;
the solid/gas suspension heat exchangers of the second and third circuit and/or the solid/gas suspension exchanger of the heating section of the second and third circuit each comprise at least one inertial separator, preferably a cyclone;
a condenser to separate at least one constituent, in particular water from the first gas, said condenser being positioned in the first circuit downstream of the reactor;
the first circuit comprises a recycling passage for recycling at least a portion of the first gas from a position downstream from the pre-heating section or the condenser to a position upstream of the reactor;
the second circuit and/or third circuit comprise a heat-recovery element, preferably said heat-recovery element being configured to exchange the heat accumulated in the second and/or third gas to the first gas at a section of the first circuit, more preferably said heat-recovery system being a heat exchanger positioned between the first circuit and the second or third circuit;
the reactor comprises at least one of the following elements: electric heater, oxy-burner, an indirect calciner such as solid heat-carrier reactor, an externally-fired calciner, or electrically-heated calciner, or a combination thereof;
the reactor comprises a fluidized bed reactor, an entraining bed reactor, a circulated fluidized bed or any combination thereof;
the externally-fired calciner comprises an intake passage, said passage being connected to the second circuit, preferably downstream from the heating section;
the second circuit and/or third circuit comprise a further heat-recovery element, in particular in the list comprising: a carbonated material preheater, an hydrated lime dryer, an alternative fuel drier, a steam boiler, a heat recovery steam generator, a gas turbine, an amine-based CO₂ capture apparatus, a thermal swing adsorption apparatus or a cryogenic refrigeration apparatus;
a fourth selective separation means connecting the second and the third circuit allowing the transfer of the hydrated particles from the second circuit to the third circuit while substantially preventing the passage of gases preferably the fourth selective separation means being connected to an outlet passage of the hydration section and an inlet of the dehydrating section.

The present disclosure also relates to a device for a device for the decarbonation of limestone, dolomite or other carbonated materials, for carrying out the process according to the present disclosure, comprising a device for the decarbonation of limestone, dolomite or other carbonated materials and hydration of said decarbonated limestone, dolomite or other carbonated materials, according to the present disclosure, and a dehydrating section.

According to specific embodiments of the present disclosure, the device comprises one or more of the following features:
the dehydrating section is positioned in the second circuit downstream from the cooling section of the second circuit, preferably said dehydrating section comprising a solid/gas suspension heat exchanger.
the dehydrating section is positioned in the third circuit downstream from the cooling section of the third circuit, preferably said dehydrating section comprising a solid/gas suspension heat exchanger;
a fourth selective separation means connecting the second and the third circuit allowing the transfer of the hydrated particles from the second circuit to the third circuit while substantially preventing the passage of gases, preferably the fourth selective separation means being connected to an outlet passage of the hydration section and an inlet of the dehydrating section.

### BRIEF DESCRIPTION OF THE DRAWINGS

Preferred aspects of the present disclosure will now be described in more detail with reference to the appended drawings, wherein same reference numerals illustrate same features.

FIG. 1 shows an illustrative device for the decarbonation of limestone, dolomite or other carbonated materials and hydration of said decarbonated limestone, dolomite or other carbonated materials.

FIG. 2 shows an embodiment in which hydration section comprises a fluidized bed reactor fed with decarbonated particles, liquid water and/or water steam, and optionally a diluting gas.

FIG. 3 shows the embodiment of FIG. 2 further comprising a cooling section positioned in the second circuit downstream from the hydration section.

FIG. 4 shows the embodiment of FIG. 3 comprising a further cooling section in which the hydrated particles are transferred and separated from the second circuit.

FIG. 5 is another illustrative embodiment of the present disclosure, differing from FIG. 4 in that the hydrating section comprises a paddle mixer slaker.

FIG. 6 is another illustrative embodiment of the present disclosure, differing from that of FIG. 3 in that the hydration section comprises a paddle mixer slaker and the heat contained in the second gas is recovered and used.

FIG. 7 is another illustrative embodiment of the present disclosure, differing from that of FIG. 6 in that the second gas is heated indirectly by the hydration reaction taking place in the hydration section.

FIG. 8 is another illustrative embodiment of the present disclosure, differing from that of FIG. 6 in that the second gas is fed to a slaked lime dryer for reducing the water content of the hydrated particles extracted from the paddle mixer slaker.

FIG. 9 is another illustrative embodiment of the present disclosure, differing from that of FIG. 5 in that a third circuit is present.

FIG. 10 illustrates a more specific embodiment according to FIG. 1, in which a third circuit is present.

FIG. 11 is similar to the embodiment of FIG. 10 except that the first, second and third selective separation means arranged between the second and third circuits are removed to simplify the general design.

FIG. 12 is another illustrative embodiment of the present disclosure, differing from that in FIG. 11 in that the hydration unit comprises a paddle mixer slaker with a further cooling section arranged below the hydration section in which a third gas of the third circuit circulates.

FIG. 13 represents a further embodiment of the present disclosure in which the pressure in the hydration section is maintained above the atmospheric pressure.

FIG. 14 is another illustrative embodiment of the present disclosure, differing from that of FIG. 2 in that a compression and purification unit CPU is positioned downstream from the first circuit so that the first gas is purified before being for instance sequestered.

FIG. 15 is another illustrative embodiment of the present disclosure, differing from FIG. 3 in that it comprises an arrangement enabling the production of high pressure and temperature steam in a heat recovery steam generator (HRSG) for subsequent usage in a steam turbine.

FIG. 16 shows a further embodiment comprising two gas circuits kept separated with a single sealing device.

FIG. 17 is another illustrative embodiment of the present disclosure, differing from the embodiment in FIG. 16 in that moisture-laden calcination gas is recirculated back into the reactor and in that only the removed first gas is dried.

FIG. 18 is another illustrative embodiment of the present disclosure, differing from that in FIG. 16 in that the recirculated calcination gas or the mixture of recirculated calcination gas and pure O₂ is then preheated in a gas-to-gas heat exchanger with the energy from the third circuit gas reclaimed from the cooling of particles of decarbonated materials and the hydrated materials.

FIG. 19 is another illustrative embodiment of the present disclosure, differing from that in FIG. 3 in that two gas circuits are kept separated by further sealing device (i.e. selective separation means) and in that a heating section is arranged downstream from the cooling section of the second circuit.

FIG. 20 is another illustrative embodiment of the present disclosure, in which the two gas circuits and are kept separated by possibly three or more sealing devices (i.e. selective separation means).

FIG. 21 depicts a reactor as an indirect calciner whose exhaust gas is fed into the third circuit via an exhaust passage.

FIG. 22 is another illustrative embodiment of the present disclosure, differing from that in FIG. 21 in that the second gas and not the third gas accomplishes the preheating of a portion of the carbonated materials, which is then directly sent into the burning zone of the indirect calciner.

FIG. 23 is another illustrative embodiment of the present disclosure, in which the decarbonated particles are cooled down in a cooling section of the third circuit before being transferred to the hydration section of the second section.

FIG. 24 is another illustrative embodiment of the present disclosure, differing from that of FIG. 23 in that the third circuit comprises a further cooling section positioned upstream from said cooling section where the hydrated particles are cooled.

FIG. 25 is another illustrative embodiment of the present disclosure, differing from that of FIG. 23 in that the third circuit comprises an additional cooling section positioned upstream from the cooling section, where the carbonated particles are further cooled before they are fed to the hydration section.

FIG. 26 is another illustrative embodiment of the present disclosure, differing from that of FIG. 23 in that the third circuit is fed with a combustion gas, for instance a dioxygen enriched composition.

FIG. 27 is another illustrative embodiment of the present disclosure, comprising an intermediate step of forming hydrated particles (e.g. hydrated lime) according to any of the embodiments shown in the previous figures.

FIG. 28 is a more specific embodiment of that of FIG. 27 based on that of FIG. 21 in which the burner supplied with the third gas is removed.

FIG. 29 is another illustrative embodiment of the present disclosure, derived from FIG. 27, differing from that of FIG. 3 in that the dehydrating section is positioned downstream from the cooling section of the second circuit.

FIG. 30 is another illustrative embodiment of the present disclosure, illustrating a CO2 capture process known as calcium looping.

FIG. 31 is another illustrative embodiment of the present disclosure, illustrating an alternative calcium looping process in which a sorbent, namely decarbonated materials/particles (e.g. quick lime) is contacted with CO₂-containing gas and is then converted in carbonated materials/particles (e.g. calcium carbonates).

FIGS. 32A-32F depict examples of selective separation means described herein, in particular a loop seal (FIG. 32D), a fluid seal-pot (FIG. 32E), a “Dollar” plate (FIG. 32F), a J valve (FIG. 32B), an L valve (FIG. 32C), and a trickle valve (FIG. 32A).

### LIST OF REFERENCE SYMBOLS

2 First circuit, calcination circuit
4 First (entraining) gas
6 Carbonated particles
7 Water (as liquid and/or steam)
8 Reactor/first reactor
12 Second circuit
12′ Third circuit
14 Second gas
14′ Third gas
16 Decarbonated particles
16′ Further decarbonated particles
17 Hydrated particles
20, 20′, 20″,20″′, Selective separation means, sealing device 20″″, 21, 21′
22 Cooling section of the second circuit
22′ Further cooling section of the second circuit
22″ Cooling section of the third circuit
22″′ Further cooling section of the third circuit
22″″ Complementary cooling section of the third circuit
22* Additional cooling section of the second circuit
22** Additional cooling section of the third circuit
23 Hydration section
24 (First) solid/gas suspension heat exchanger of the second circuit
24.1 inlet of the (first) solid/gas suspension heat exchanger of the second circuit
24.2 outlet of the (first) solid/gas suspension heat exchanger of the second circuit
24.3 return of the (first) solid/gas suspension heat exchanger of the second circuit
23 Hydration section
25 Fluidized bed reactor
25′ Paddle mixer slaker
27 Fluidized bed hydration reactor
29, 29′ dehydrating section
32 Pre-heating section of the second circuit
34 (Second) solid/gas suspension heat exchanger of the second circuit
34.1 inlet of the (second) solid/gas suspension heat exchanger of the second circuit
34.2 outlet of the (second) solid/gas suspension heat exchanger of the second circuit
34.3 return of the (second) solid/gas suspension heat exchanger of the second circuit
42 Pre-heating section of the first circuit
44 (First) solid/gas suspension heat exchanger of the first circuit
44.1 inlet of the (first) solid/gas suspension heat exchanger of the first circuit
44.2 outlet of the (first) solid/gas suspension heat exchanger of the first circuit
44.3 return of the (first) solid/gas suspension heat exchanger of the first circuit
50 Condenser
60 gas-gas heat exchanger
82 Oxy-burner
84 Externally-fired calciner
86 Second reactor
90 Recycling passage
100 Exhaust passage
110 intake passage

### DETAILED DESCRIPTION

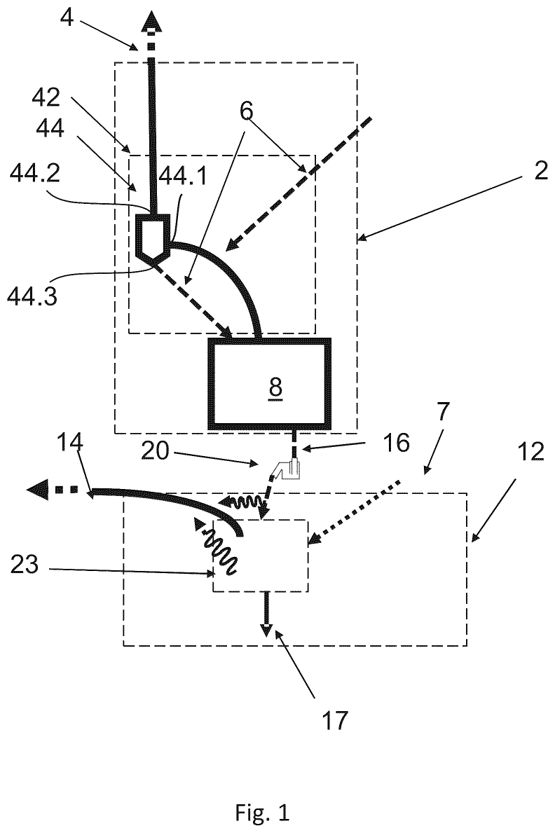

FIG. 1 shows a device for the decarbonation of limestone, dolomite or other carbonated materials and hydration of said decarbonated limestone, dolomite or other carbonated materials comprising the key features of the present disclosure. All other embodiments disclosed below are derived from the core concept disclosed in FIG. 1. In FIG. 1, the carbonated materials 6, such as limestone or dolomite in form of ground and screened particles, are fed into a first circuit 2, in which a first gas 4 circulates, said gas 4 being the exhaust gas of a reactor 8. The particles of carbonated materials 6 are entrained/conveyed to the reactor 8 where the decarbonation takes place under high temperatures. The first gas 4 is selected substantially free of nitrogen. For instance, the nitrogen represents less than 10% vol. in particular less than 5% vol. of the first gas 4 composition. This facilitates the final purification of the exhaust gas 4 into a suitable purity for downstream CO₂ use or sequestration. Furthermore, when the decarbonation is performed in an atmosphere substantially free of nitrogen, a negligible amount of NOx is generated. Indeed, NOx is likely to be formed under heat and in the presence of oxygen and nitrogen, which are the two main constituents of air. The first circuit 2 is therefore sealed from the ambient air. The first gas 4 is used to preheat the particles of carbonated materials 6. The first gas 4 mainly results from the CO₂ being released during the decarbonation process in the reactor 8 and optionally from the gas resulting from the combustion coupled to the decarbonation process. It should be noted that the first gas 4 transports the particles of carbonated materials 6 away from the reactor 8, which is a gas source for the first gas 4 stream. In order to feed the reactor 8 with the particles of carbonated materials 6, a solid/gas separation, preferably an inertial separation is performed in separator 44 such as a cyclone or a group of cyclones. Separator 44 helps not only to separate the solid materials from the gas, but also enhances heat exchanges. Indeed, the solid particles are efficiently heated by the gas before being separated thanks to a proper distribution of the solid particles in the gas stream, a vast surface area of the solid gets in contact with the gas. Consequently, the solid and gas materials reach similar temperature in a very short time (typically a fraction of seconds). This type of heat exchanger is called solid-gas heat exchanger or suspension heat exchanger 44, and can typically contain several gas-solid separators to approach a counter current contact between the first gas 4 and the carbonated particles 6. Once the carbonated particles 6 are decarbonated in the reactor 8, the decarbonated particles 16 are transferred to a second circuit 12, via a selective separation means 20 connecting the first and second circuits, 2 and 12. The selective separation means 20 (sealing device) is arranged so as to allow the transfer of the particles of decarbonated materials 16 from the first circuit 2 to the second circuit 12 while substantially preventing the passage of gases 4 to circuit 12 and gases 14 to circuit 2. This selective separation means 20 can be a siphon element, a loop seal, single or multiple flaps, table feeder, cellular wheel sluice, fluid seal-pot, “Dollar” plate, or any of the following valves: rotary valves, cone valve, J valve, L valve, trickle valve and flapper valve. The second circuit 12 comprises a hydration section 23 in which the decarbonated particles 16 in contact with at least liquid water and/or water steam 7, and optionally in the presence of a dilution gas (not shown), such as air or a dioxygen enriched composition, in particular pure dioxygen, are hydrated to obtain hydrated particles 17 comprising Ca(OH)₂ and/or Mg(OH)₂. The second gas 14 circulating in the second section 12 is at least heated by a portion of the heat generated by the hydration of the decarbonated particles 16. This heat can be recovered for subsequent usage. The heat from second gas 14 can optionally be transferred to another fluid using an indirect heat exchange element, thereby producing a dust-free heat stream for subsequent usage (not shown).

As show in FIG. 1 the conveyed decarbonated particles 16 release a portion of their thermal energy, thereby heating the second gas 14. This measure allows to cool down the decarbonated particles 16 exiting the first circuit 2 at a temperature of typically above 900° C. in order to control temperature in the hydration section 23 below a certain threshold under which thermodynamic equilibrium allows hydration to take place (e.g. below 520° C. when partial pressure of steam remains below 1 bar).

The process and the device of the present disclosure ensure that any gas mixture being in direct contact with the CaO/MgO or Ca(OH)₂/Mg(OH)₂ is substantially free of CO₂ in order to avoid any reconversion back to CaCO₃/MgCO₃. Second gas 14 is therefore substantially free of CO2 (e.g. less than 5% vol). Hence, the present disclosure allows to bring the residual amount of carbonated in the product to an acceptable level (e.g. less than 5% in weight).

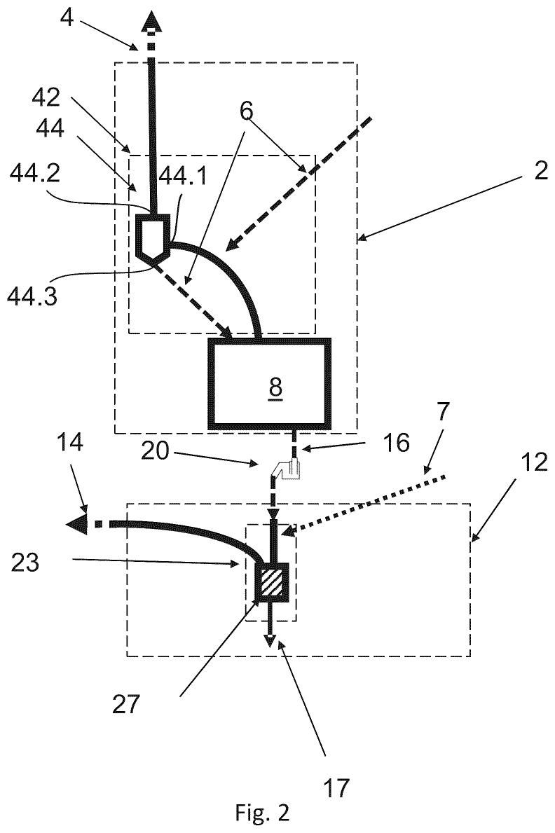

FIG. 2 shows an embodiment in which hydration section 23 comprises a fluidized bed reactor (27) fed with decarbonated particles 16, liquid water and/or water steam, and optionally a diluting gas. The second gas 14 is extracted from the hydration section (e.g. water steam, air, oxygen or a mixture thereof). The second gas 14 circulating in the second circuit 12 comprises at least a portion (i.e. the entirety or a portion) of the heat generated by the hydration of the decarbonated particles 16 and the heat transferred by the cooling of the decarbonated particles (not shown).

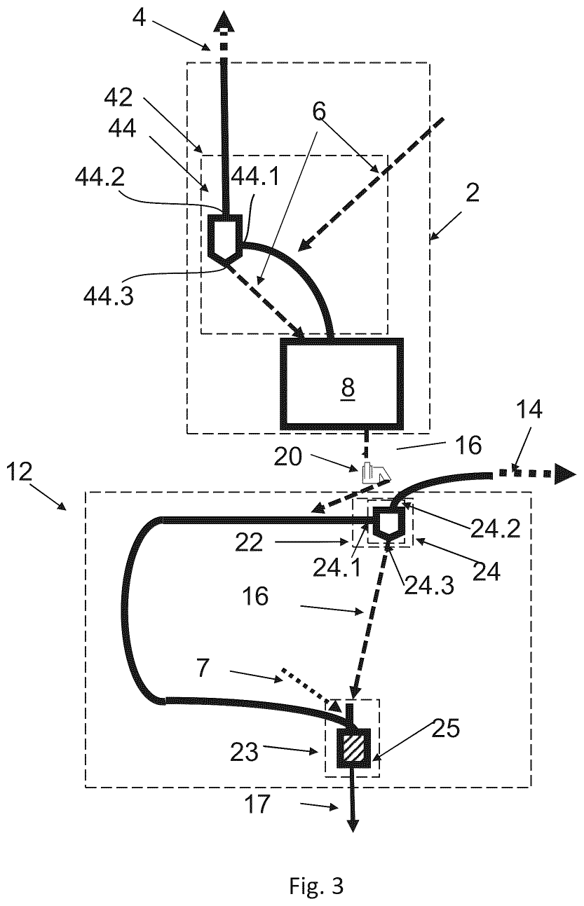

FIG. 3 shows the embodiment of FIG. 2 further comprising a cooling section 22 positioned in the second circuit 12 downstream from the hydration section 23, in which the conveyed decarbonated particles 16 release a portion of their thermal energy, thereby heating the second gas 14. The decarbonated particles 16 are then separated from a second gas 14 flow and subsequently transferred to the hydration section 23. This measure allows to cool down the decarbonated particles 16 exiting the first circuit 2 at a temperature of typically above 900° C. in order to control temperature in the hydration section 23 below a certain threshold under which thermodynamic equilibrium allows hydration to take place (e.g. below 520° C. when partial pressure of steam is about 1 bar). In FIG. 3, the second gas 14 is not only used to cool the particles of decarbonated materials 16 but also to transport them in the dedicated solid-gas heat exchanger or suspension heat exchanger 24 containing gas-solid separators such as a cyclone.

Even if FIG. 3 shows only one solid-gas heat exchanger 44, 24 for the first 2 and second circuit 12, the decarbonation device can comprise more than one cyclone, in particular two cyclones per circuit. Even a higher number of cyclones (3 to 5) can be economically justified, to ensure a more effective preheating of the carbonated material 6 or cooling of decarbonated material 16 by exploiting the counter current gas-solid contact mode achieved in similar suspension preheater or cooler set-ups described in the state of the art.

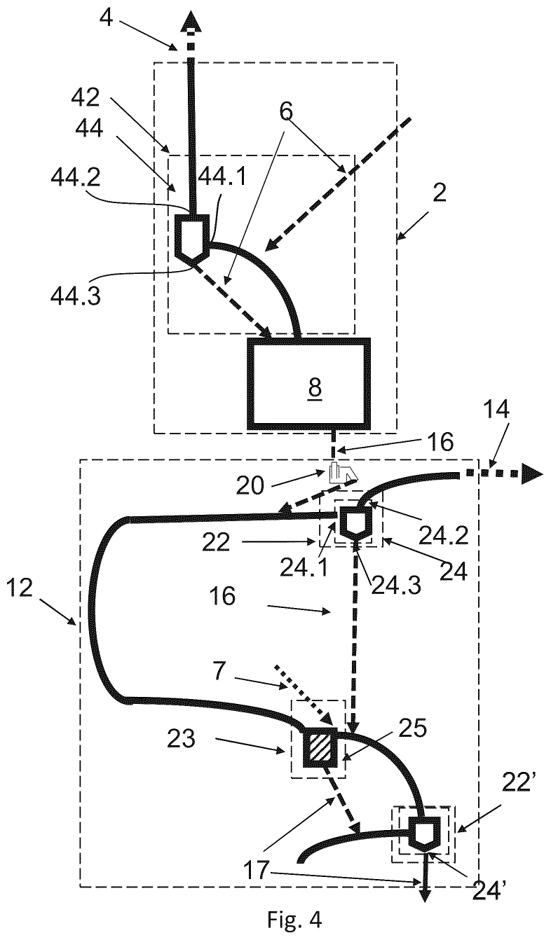

FIG. 4 shows the embodiment of FIG. 3 comprising a further cooling section 22′ in which the hydrated particles 17 are transferred and separated from the second circuit 12. The further cooling section 22′ is positioned upstream from the hydration section 23 of the second circuit 12. The hydrated particles 17 release in the further cooling section 22′ a portion of their thermal energy, thereby heating the second gas 14 flow before said gas 14 enters the hydration section 23

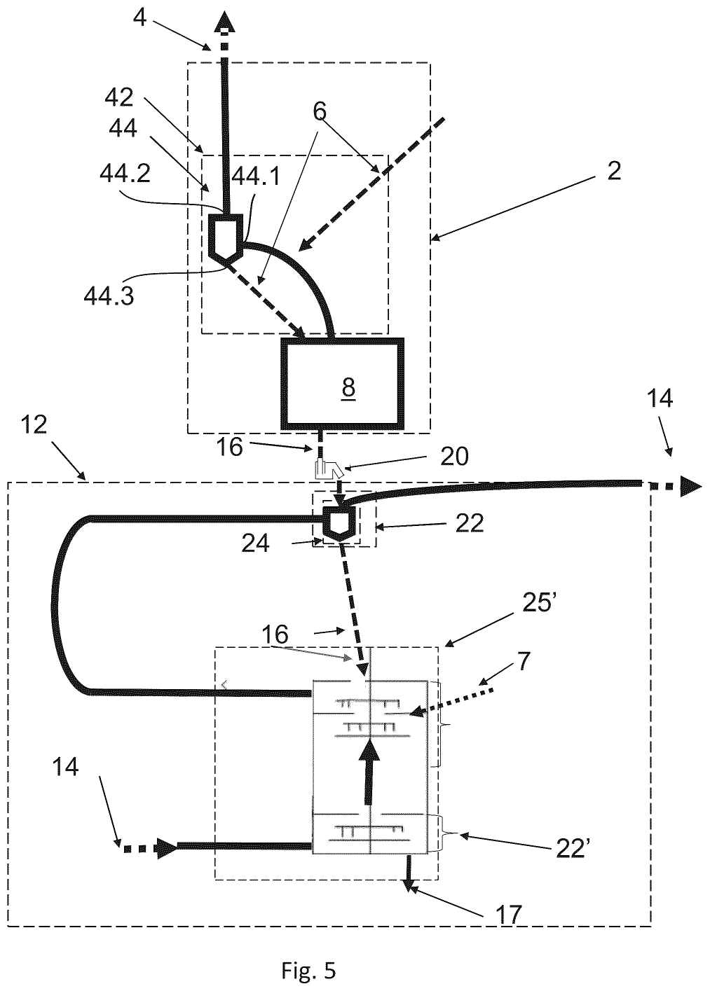

FIG. 5 differs from FIG. 4 in that hydrating section 23 comprises a “paddle mixer” slaker which is the state-of-the-art technology for hydrating lime. It consist typically in several successive chambers in which quicklime reacts with hydration water while being subjected to strong mixing. Paddle mixer slaker 25′ depicted in FIG. 5. Further comprise a further cooling section 22′.

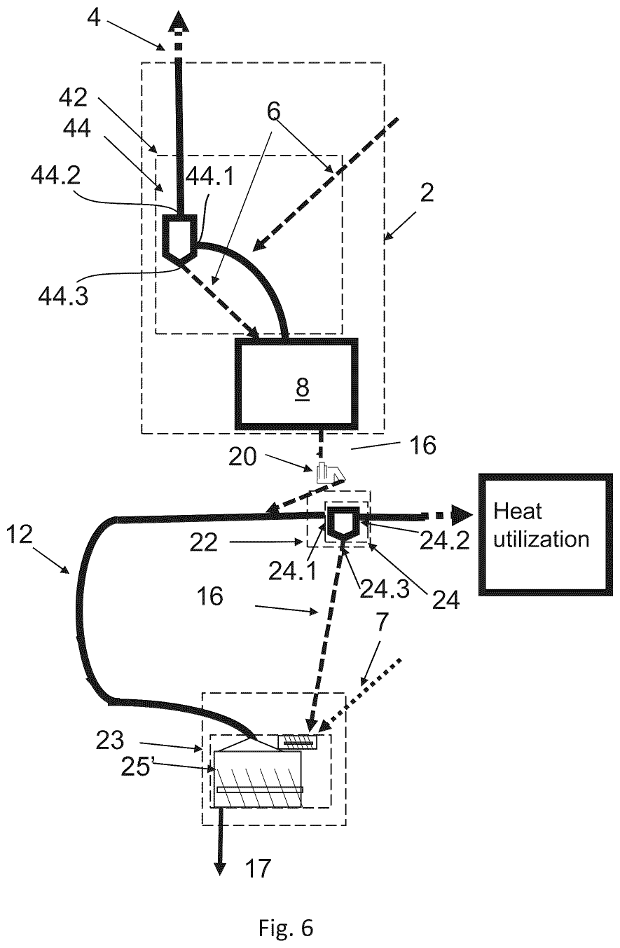

The embodiment in FIG. 6 differs from that of FIG. 3 in that the hydration section 23 comprises a paddle mixer slaker 25′ and that the heat contained in the second gas 14 is recovered and used for instance for carbonated material (such as limestone and/or dolomite) preheating, alternative fuel drying, hydrated lime drying, generating mechanical work and/or electricity in a turbine, providing heat for a CO2 treatment process such as an amine gas treating apparatus, a thermal swing adsorption apparatus, or a cryogenic refrigeration apparatus or any CO2 treatment process. The heat contained in the second gas 14 stems from the heat of hydration reaction in the hydration section 23 and sensible heat of the decarbonated particles 16.

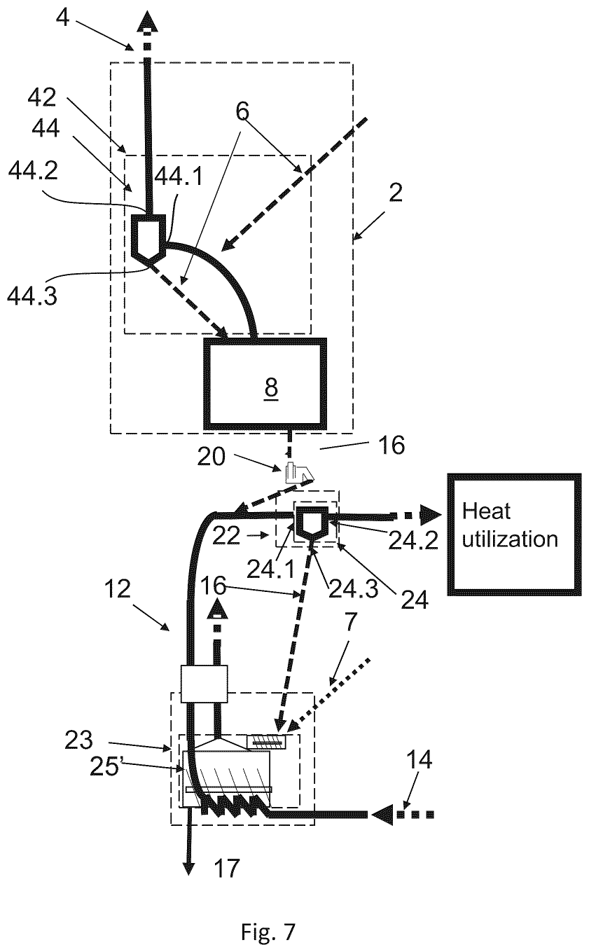

The embodiment in FIG. 7 differs from that of FIG. 6 in that the second gas 14 is heated indirectly by the hydration reaction taking place in the hydration section 23. A first heat exchanger unit, in which the second gas 14 circulates, is provided on one or more paddle mixer slaker 25′ walls for absorbing the hydration reaction heat. A second heat exchanger unit is provided downstream from the first heat exchanger unit. Moreover heat from the gas extracted from the slaker 25′ is transferred to the second gas 14 via the second heat exchanger unit.

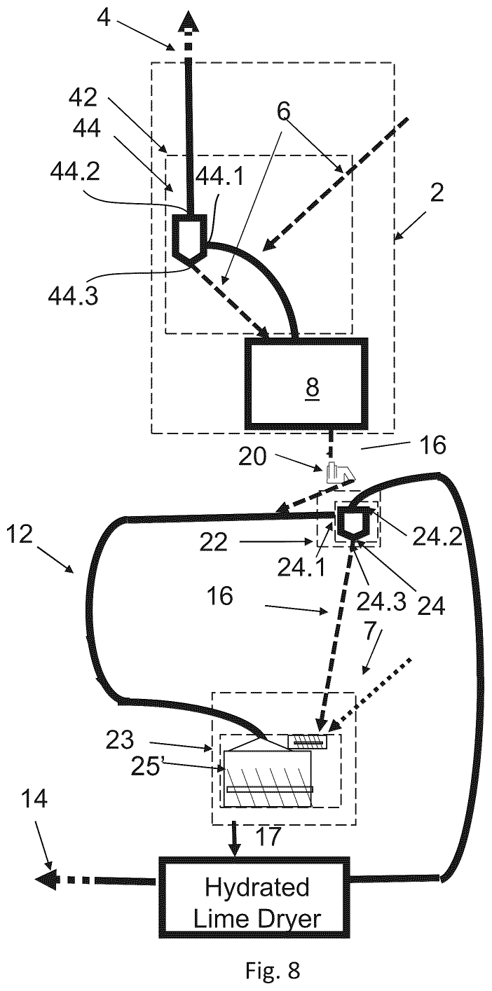

The embodiment in FIG. 8 differs from that of FIG. 6 in that the second gas 14 is fed to a slaked lime dryer for reducing the water content of the hydrates particles 17 extracted from the paddle mixer slaker 25′.

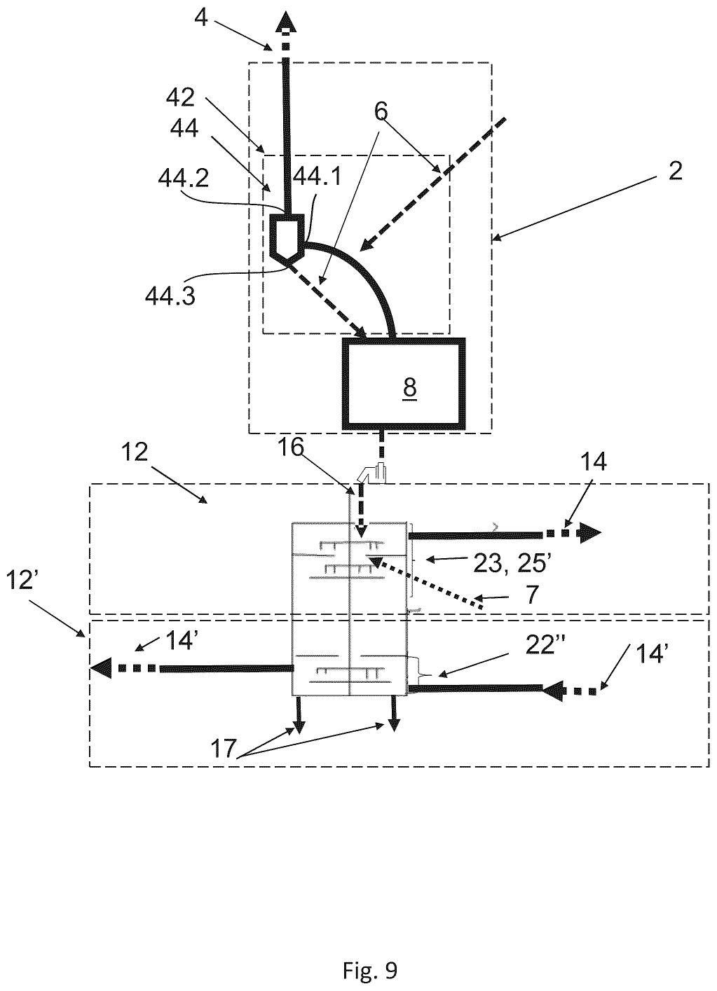

A further embodiment of the present disclosure is shown in FIG. 9. This embodiment differs from that of FIG. 5 in that a third circuit 12′ is present. This circuit 12′ comprises a cooling section 22″ in which the hydrated particles 17 are cooled by a third gas 14′ circulating in said third circuit 12′. Moreover, the hydration section 23, 25′ comprises a paddler mixer slaker 25′ as shown in FIG. 5.

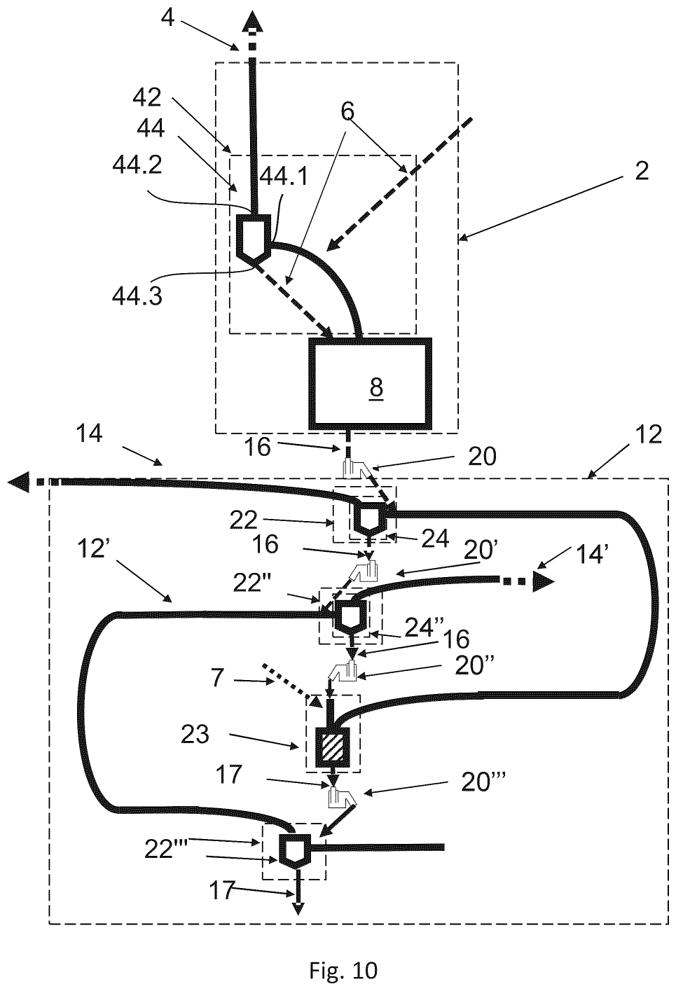

FIG. 10 illustrated a more specific embodiment according to FIG. 1, in which a third circuit 12′ is foreseen. In this embodiment, the second circuit 12 and the third circuit 12″ are sealed from another. The isolation of the second 12 and third circuit 12′ is needed when the corresponding gases 14, 14′ present different compositions that should not mix. For instance, the second 14′ or third 14″ gas may be a sensibly pure oxygen composition to be feed to the reactor 8 as combustive gas (not shown). The dilution of the sensibly pure oxygen composition with another gas containing nitrogen (e.g. air or water and air mixture) is to be avoided because it will reduce the CO₂ purity of the first gas 4 produced in reactor 8.

In FIG. 10, the decarbonated particles 16 separated from the cooling section of the second circuit 2 are transferred from the second circuit 12 to a cooling section 22″ of the third circuit 12′, in which the third gas 14′ circulates. The decarbonated particles 16 are conveyed by said third gas 14′ and release a portion of their thermal energy to said third gas 14′. In FIG. 10, the cooling section 22 of the second circuit 12 and the cooling section 22″ of the third circuit 12′ are separated by a first selective separation means 20′ allowing the passage of solids while substantially preventing the passage of the gases 14, 14′.

Subsequently, the decarbonated particles 16 are transferred to the hydration section 23 of the second circuit 12. A second selective separation means 20″ allowing the passage of solids while substantially preventing the passage of the gases 14, 14′, is arranged between the cooling section 22″ of the third circuit 12′ and the hydration section 23 of the second circuit 12.

Hydrated particles 17 formed in the hydration section 23 are then transferred to a further cooling section 22″′ of the third circuit 12′ in which the hydrated particles 17 release a portion of their thermal energy, wherein the second 12 and third circuits 12′ are separated by a third selective separation means 20″′ allowing the passage of solids while substantially preventing the passage of the gases 14, 14′. Finally, once the hydrated particles 17 are cooled to a desired temperature in the further cooling section 22″′, they are separated. The further cooling section 22″′ is arranged upstream from the cooling section 22″ of the third circuit 12′.

The embodiment in FIG. 10 allows adjusting temperature of the different streams in order to control temperature in the hydrating section 23 and optimizing recovery of the sensible heat.

At least one selective separation means 20, 20′, 20″, 20″′ illustrated in FIG. 10 comprise or consist in a siphon element, a loop seal, single or multiple flaps, table feeder, cellular wheel sluice, fluid seal-pot, “Dollar” plate, or any of the following valves: rotary valves, cone valve, J valve, L valve, trickle valve and flapper valve.

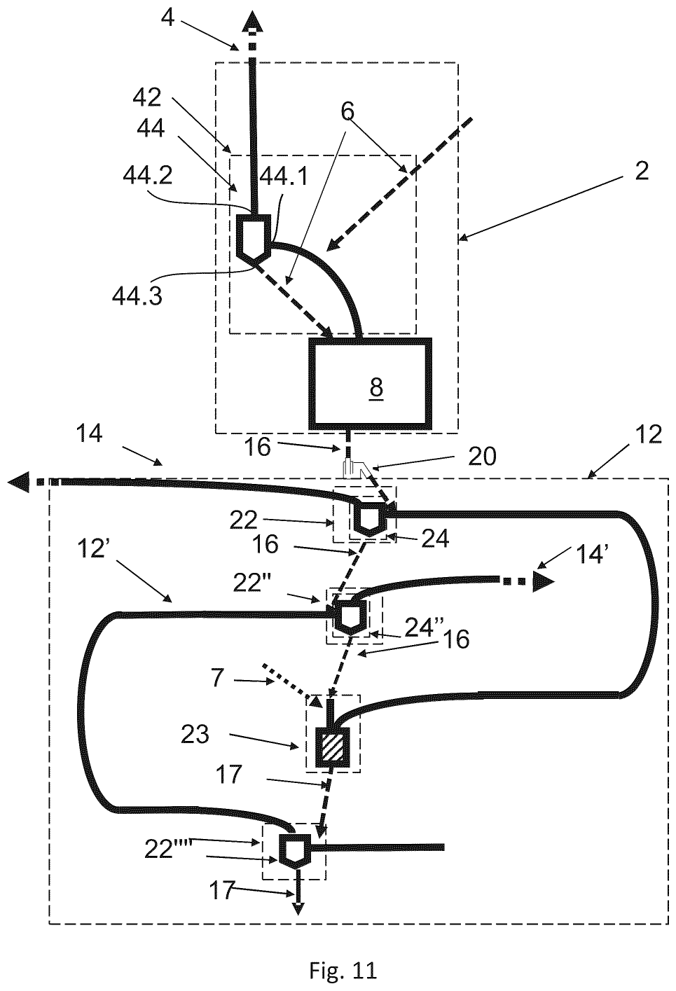

The embodiment in FIG. 11 is similar to that of FIG. 10 except that the first, second and third selective separation means 20′, 20″, 20″′ arranged between the second 12 and third 12′ circuits are removed to simplify the general design in case a sealed interface between the second 12 and third 12′ is not required, for instance when pressure differences or gas compatibility between these circuits 12, 12′ permit such a simplification.

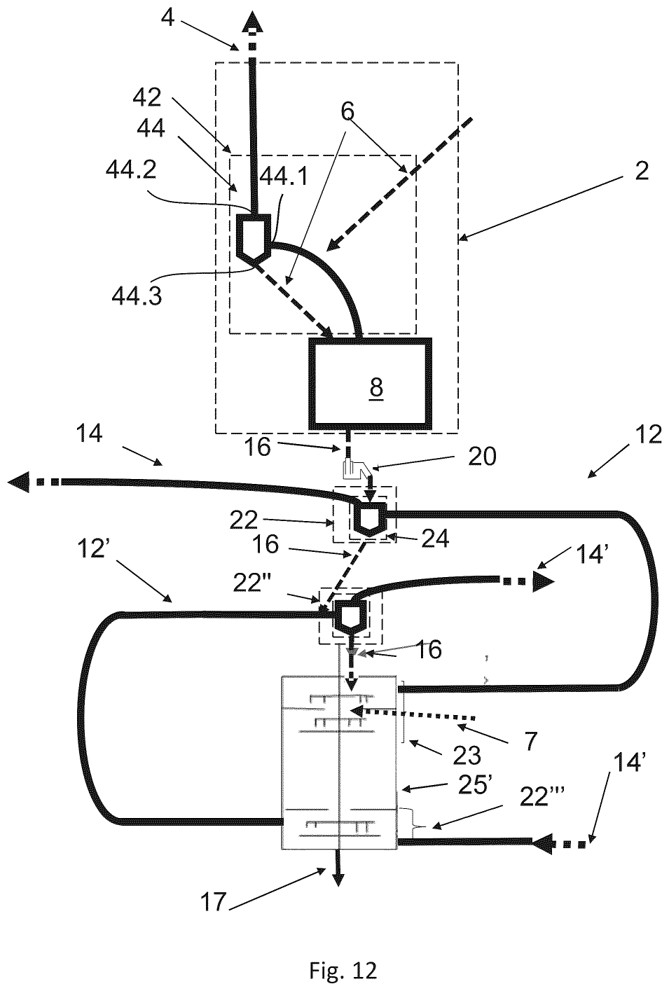

The embodiment in FIG. 12 differs from that in FIG. 11 in that the hydration unit 23 comprises a paddle mixer slaker 25′ with a further cooling section 22″′ arranged below the hydration section 23 in which a third gas 14′ of the third circuit 12′ circulates.

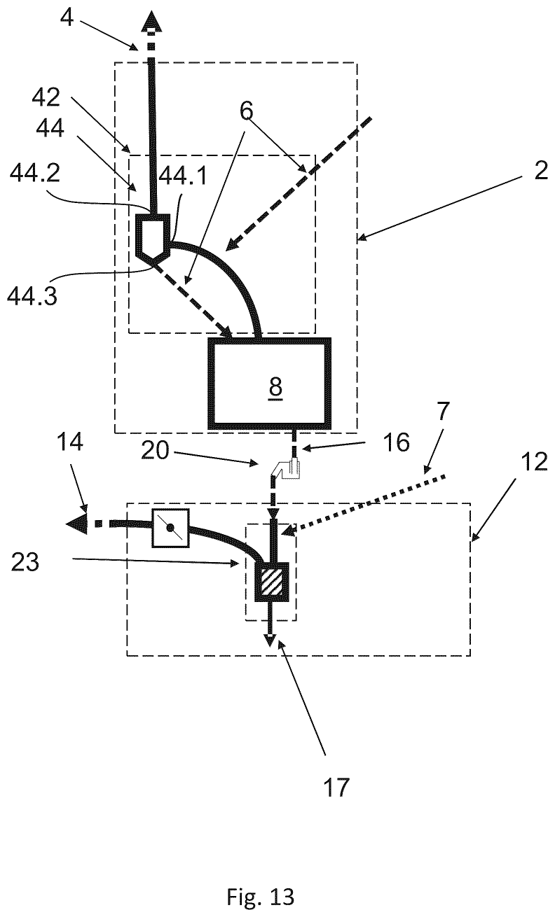

The temperature, at which hydration reaction take place is limited by an upper threshold. For instance 520° C. when partial pressure of H₂O is around 1 bar. Above this temperature the equilibrium is inverted and the calcium hydrate decomposes into quicklime and water. Therefore, without any compensating measures, the heat of the hydration reaction can only be recovered at relatively low temperature. In order to overcome this limitation, FIG. 13 represents a further embodiment of the present disclosure in which the pressure in the hydration section 23 is maintained above the atmospheric pressure, in particular above at least 1 bar above the atmospheric pressure using a valve arranged in the second circuit 12 and/or a compressor (not shown). Increasing the pressure in the hydration section 23 enables to shift the hydration equilibrium temperature towards higher temperature. For instance, one can perform hydration at (around) 560° C. (respectively 670° C.) if pressure in the hydrating section 23 is (around) 2 bars (respectively 10 bars).

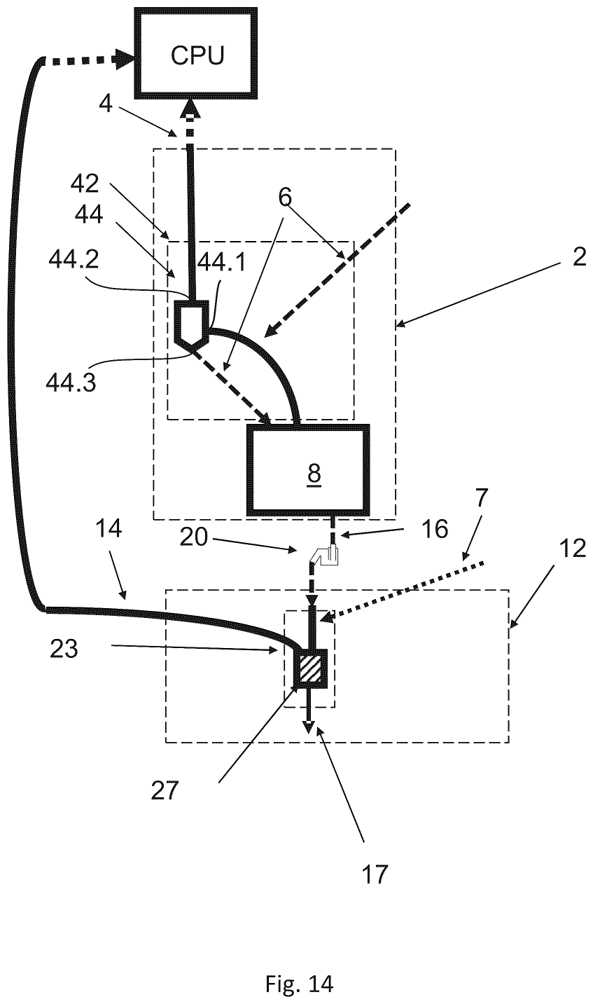

The embodiment illustrated in FIG. 14 differs from that of FIG. 2 in that a compression and purification unit CPU is positioned downstream from the first circuit 2 so that the first gas 2 is purified before being for instance sequestered. The heat recovered from the second circuit 12 is used by the compression and purification unit CPU comprising for instance a cryogenic refrigeration apparatus.

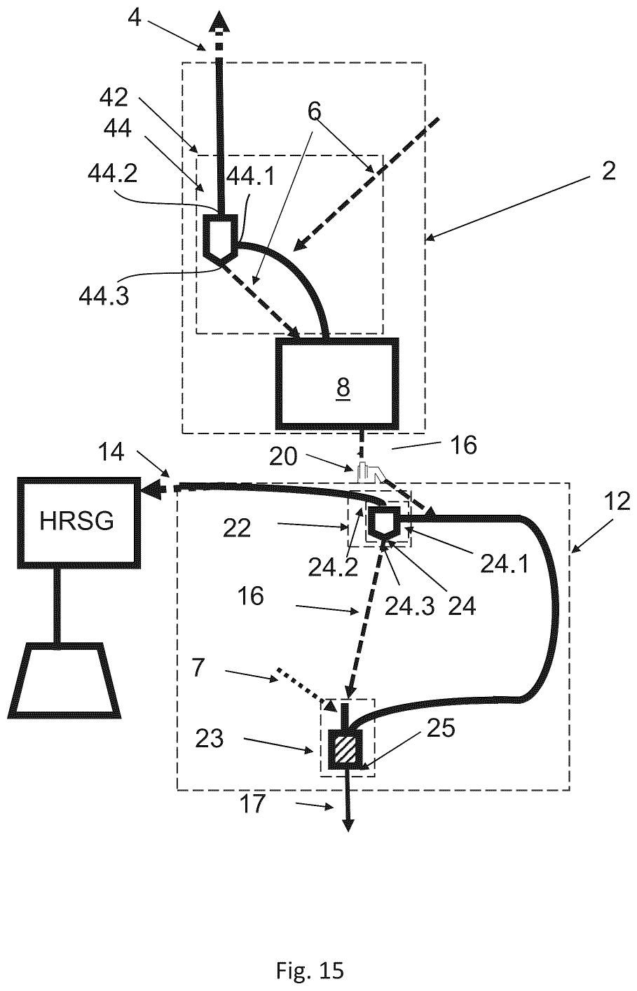

The embodiment represented in FIG. 15 differs from FIG. 3 in that it comprises an arrangement enabling the production of high pressure and temperature steam in a heat recovery steam generator (HRSG) for subsequent usage in a steam turbine. Preferably, the modelized operating conditions for this embodiment are the followings:
Pressure in hydrating section 23 is (about) atmospheric pressure;
Decarbonated material 16 consist in quicklime CaO and is fed in hydrating section at (about) 450° C.;
Liquid water (7) is fed in hydrating section at (about) 20° C.;
Water/quicklime stoichiometric ratio is fixed at 2.57 mol/mol or equally 0.826 kg of water per kg of quicklime;
Hydration reaction enthalpy is (about) 1.1 MJ/kg of quicklime (exothermal);
Temperature of Ca(OH)₂ product and excess water after completion of hydration reaction is is (about) 124° C.;
(About) 1.32 kg of hydrated material Ca(OH)₂ 17 is produced and discharged from hydration reactor;
Excess water is vaporized resulting in a steam flow 14 of (about) 0.50 kg at (about) 124° C. which is equivalent to a thermal energy flow rate of (about) 1.33 MJ/kg of quicklime;
Steam flow 14 corresponds to (about) 0.63 Nm3 to per kg of quicklime and is used as second entraining gas in cooling section 22;
Decarbonated material 16 is fed in cooling section 22 at (about) 950° C., thereby releasing a portion of its thermal energy to the second entraining gas 14;
Second entraining gas 14 therefore leaves cooling section 22 heated to (about) 618° C. corresponding to a thermal energy flow rate of (about) 1.82 MJ/kg of quicklime;
Said second entraining gas 14 is sent to a heat recovery steam generator to produce high pressure steam able to run a steam turbine (about 40% energy efficiency) producing (about) 202 kWh of electricity per kg of quicklime.

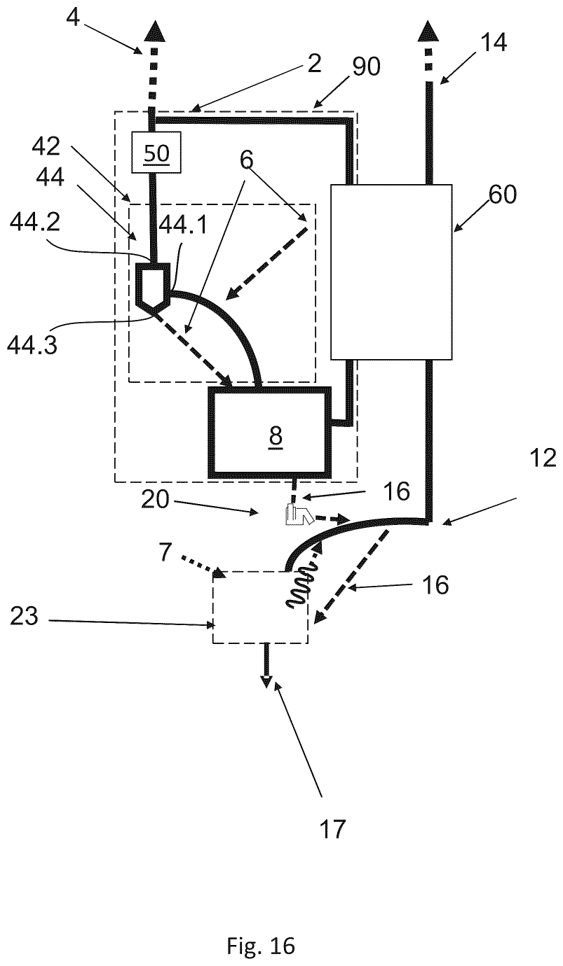

FIG. 16 shows a further embodiment comprising two gas circuits, namely the first 2 and the second 12 circuit, wherein the circuits 2, 12 are kept separated with a single sealing device 20 (a selective separation means, in particular a loop seal). In this embodiment, the entirety of the gas resulting from the calcination (first gas 4 leaving the reactor 8) can be processed through an evaporative condenser 50, removing H₂O, allowing to reach a high level of CO₂ (e.g. CO₂>85% dry vol.). Part of the dry gas 4 abandoning the evaporative condenser 50 is removed from the first circuit 2 as dry first gas 4, to be conditioned for carbon sequestration (CCS) or carbon utilization (CCU), while the rest is recirculated back into the first circuit 2 via a recycling passage 90. A source of relatively pure O₂ is either mixed with the recirculated first gas 4 or is introduced in the reactor 8 close to the fuel injection area(s). The quantities of O₂ and fuels injected are adjusted to ensure that the waste heat in the gases after combustion and calcination is just sufficient to adequately preheat the incoming carbonated materials 6 while also maintaining a gas exit temperature just high enough to avoid H₂O condensation, which avoids fouling of the dust filter. The recirculated calcination gas or the mixture of recirculated calcination gas and pure O₂ is then preheated in a gas-to-gas heat exchanger 60 with the energy from the second circuit 12 gas reclaimed from the cooling of particles of decarbonated materials 16 and the heat generated during the hydration of the said materials. The preheated recirculated gas is then directed back into the calcination zone (reactor 8) for combustion of a suitable fuel stream entering the reactor 8.

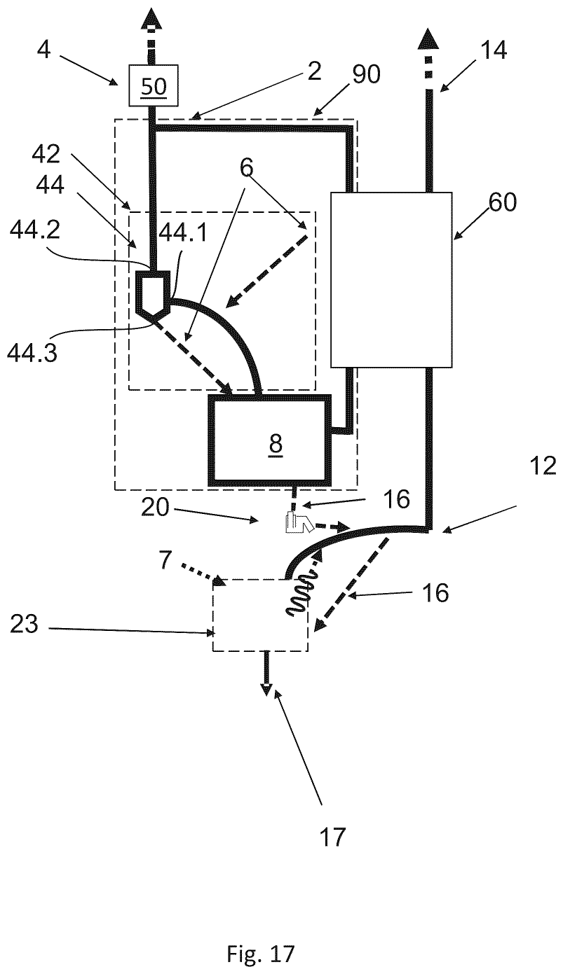

The embodiment in FIG. 17 differs from the embodiment in FIG. 16 in that moisture-laden calcination gas (first gas 4) is recirculated (stream 90) back into the reactor 8 and in that only the removed, first gas 4, is dried. This results in a higher moisture content in the calcination zone of the reactor 8 which lowers the partial pressure of CO₂, thereby aiding the liberation of CO₂ from the carbonated material 6 in reactor 8. This can slightly lower the peak temperature needed in the calciner as well as possibly influence the water reactivity (T₆₀) of the product (e.g. lime).

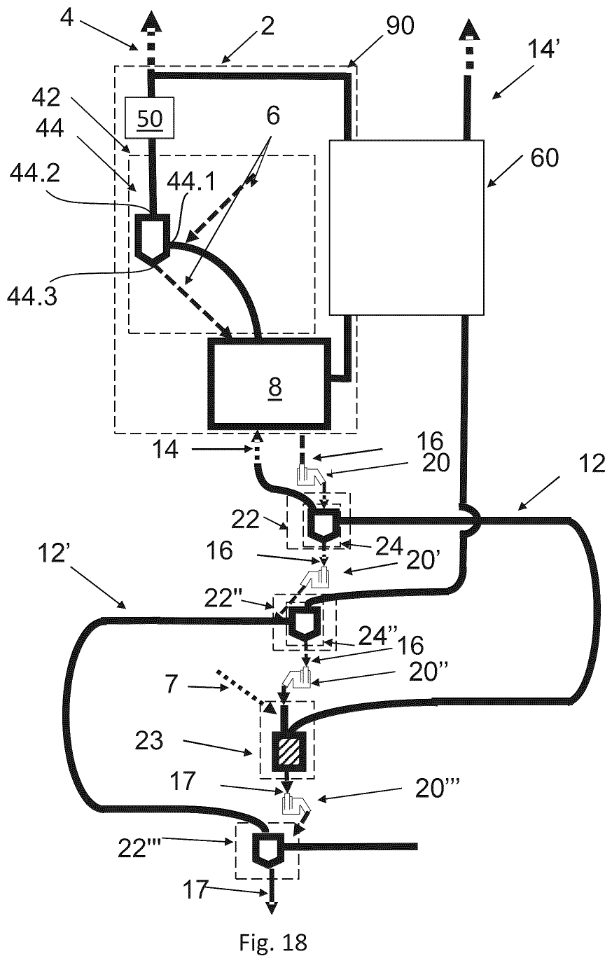

The embodiment illustrated in FIG. 18 differs from that in FIG. 16 in that the recirculated calcination gas or the mixture of recirculated calcination gas and pure O₂ is then preheated in a gas-to-gas heat exchanger 60 with the energy from the third circuit 12′ gas reclaimed from the cooling of particles of decarbonated materials 16 and the hydrated materials 17. The preheated recirculated gas is then directed back into the calcination zone (reactor 8) for combustion of a suitable fuel stream entering the reactor 8. Furthermore, the second gas 14 essentially consists in a combination of a combustive gas (e.g. relatively pure O₂) alone or in combination with H₂O. The second gas 14 is heated by the sensible heat of the decarbonated material 16 and the hydration reaction heat is fed in the reactor 8. The introduction of H₂O (water steam) in the reactor 8 allows to limit the peak calcination temperature. Further, H₂O can be easily removed from the first circuit 2 via the condenser 50 producing a relatively pure CO₂ stream.

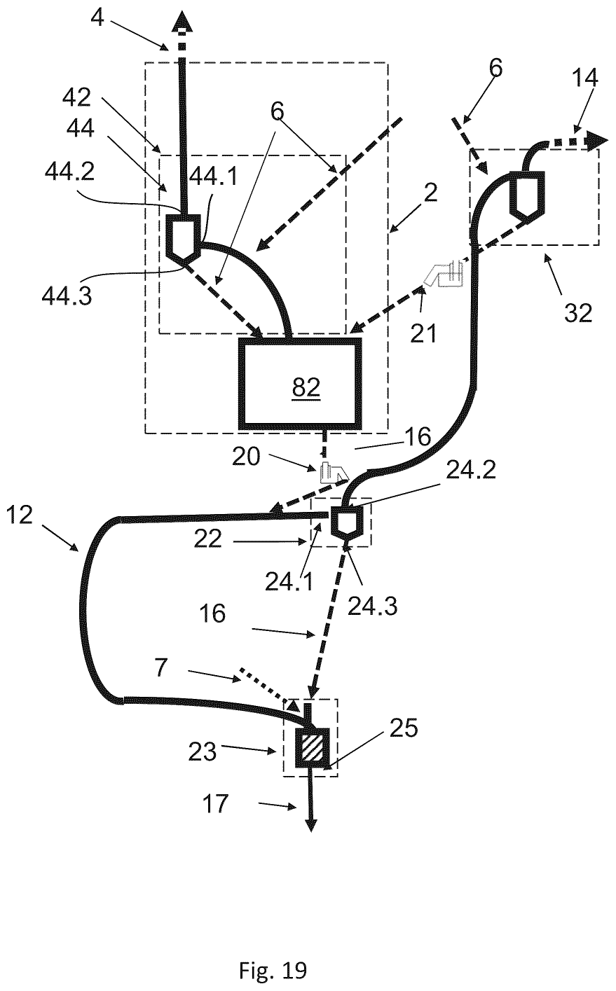

The embodiment in FIG. 19 differs from that in FIG. 3 in that two gas circuits 2, 12 are kept separated by further sealing device (i.e. selective separation means) 21 and in that a heating section 32 is arranged downstream from the cooling section 22 of the second circuit 12. Contrary to the embodiment in FIG. 17, there is no recirculation of any gases back into the calcination circuit (first circuit 2). The fuel (not shown in FIG. 19) is combusted with substantially pure oxygen. The calcination gas (first gas 4) can be processed through an evaporative condenser (not shown) removing the H₂O resulting in a CO₂>85% dry vol. for sequestration or usage. Since the energy in the first gas 4 just after combustion and calcination is not sufficient to preheat 100% of the carbonated material 6, only a portion of the ambient temperature carbonated material 6 is conveyed into the calcination circuit (first circuit 2) for preheating. The maximal pre-heatable quantity of material 6 is conveyed into the calcination circuit to make sure that it is adequately preheated (about 800° C.) before it enters the calcination zone (reactor 8, in particular an oxy-burner 82). The balance of carbonated material 6 is conveyed into a heating section 32 in the second circuit 12 (preferably a gas-solid suspension type 34) downstream of the hot second gas 14 exiting the product cooling heat exchanger (cooling section 22) and the hydration section 23. The hot second gas 14 accomplishes the preheating of this portion of the carbonated material 6, which is then directly sent into the calcination zone (reactor 8, in particular an oxy-burner 82) of the calcination circuit (first circuit 2). A second sealing device (i.e. selective separation means) 21 can be provided to transfer the preheated carbonated material 6 leaving the carbonated material preheating heat exchanger 34 in the second circuit 12, directly into the calcination zone of the calcination circuit, bypassing the preheating heat exchanger 42 in the calcination circuit 2.

The advantage of this embodiment is that it eliminates the relatively expensive and possibly maintenance-intensive gas-to-gas heat exchanger 60 of the previous two embodiments.

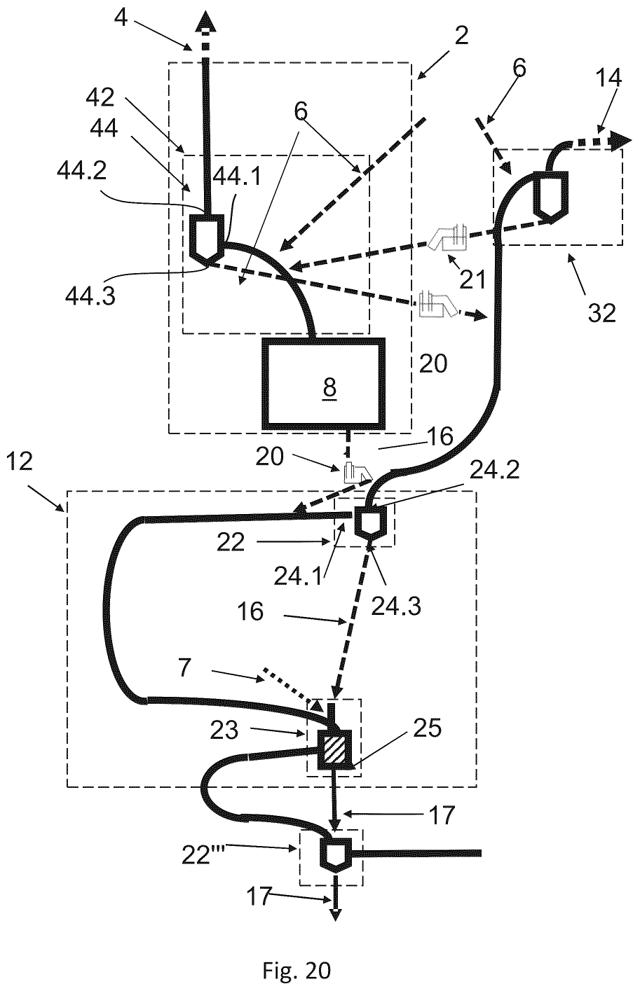

In the embodiment illustrated in FIG. 20, the two gas circuits 2 and 12 are kept separated by possibly three or more sealing devices (i.e. selective separation means) 20, 21. This solution allows a stage heating (with a couple of steps) of the carbonated particles 6, in order to reduce the temperature differences during the heat exchanges. In this embodiment, there is no recirculation of any gases back into the calcination circuit.

Preferably, the modelized operating conditions for this embodiment are the followings:
Pressure is (about) atmospheric pressure;
Decarbonated material 16 consist in quicklime CaO and is fed in hydrating section at (about) 450° C.;
Liquid water (7) is fed in hydrating section at (about) 20° C.;
Water/quicklime stoichiometric ratio is fixed at 1.5 mol/mol or equally 0.48 kg of water per kg of quicklime;
Hydration reaction enthalpy is (about) 1.1 MJ/kg of quicklime (exothermal);
(About) 1.32 kg of hydrated material Ca(OH)₂ 17 is produced and discharged from bottom of the hydration to a further cooling section 22″′;
Temperature of Ca(OH)₂ product is cooled in section 22″′ to (about) 100° C. by a flow of ambient air equivalent to 2.16 kg/kg of quicklime;
Said air is used as diluting gas in the hydrating section 23 and mixes with 0.16 kg of excess water (vaporized) to form a second gas 14 at temperature of (about) 368° C.
Second gas 14 corresponds to (about) 1.93 Nm3 per kg of quicklime and is used as second entraining gas in cooling section 22;
Decarbonated material 16 is fed in cooling section 22 at (about) 900° C., thereby releasing a portion of its thermal energy to the second gas 14;
Second gas 14 therefore leaves cooling section 22 heated to (about) 529° C. and is used as entraining gas in second preheating section 32, thereby releasing a portion of its thermal energy to the carbonated material 6;
(About) 1.76 kg of limestone (carbonated material 6) is fed to reactor 8 with (about) 3.5 GJ of methane and corresponding amount of substantially pure oxygen;
First gas 4 consist in a mixture of CO2 and steam resulting from combustion of methane and decarbonation of carbonated materials at (about) 900° C.;
First gas 4 corresponds to (about) 0.7 Nm3/kg of quicklime and is used as entraining gas in first preheating section 42, thereby releasing a portion of its thermal energy to the carbonated material 6;
First and second preheating sections consist in a staged arrangement of gas suspension heat exchangers allowing preheating of carbonated material 6 from 20° C. to (about) 874° C. prior to feeding in reactor 8;
First gas 4 (respectively second gas 14) leaves first preheating section 42 (respectively second pre-heating section) at (about) 243° C. (respectively (about) 246° C.)

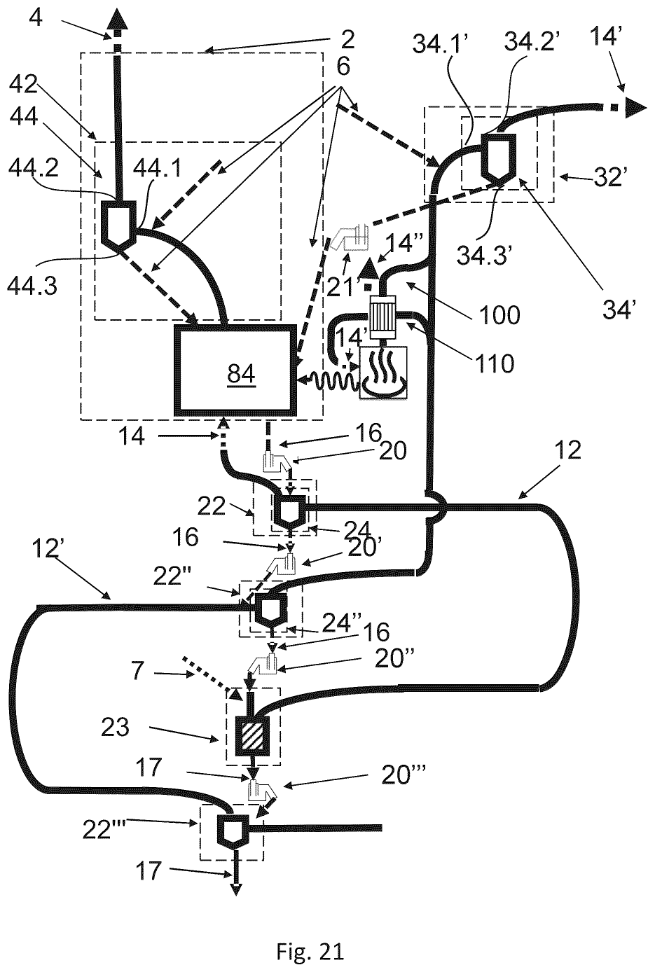

The embodiment represented in FIG. 21 differs from that in FIG. 18 in that at least a part of the third gas 14′ (comprising for instance air heated by the decarbonated particles 16 in the cooling section 22 and the hydrated particle 17 in the further cooling section 22″′) is used for the burner of the indirect calciner 84. Contrary to the embodiment in FIG. 18, there is no recirculation of any gases back into the calcination circuit (first circuit 2). The hot third gas 14′ accomplishes the preheating of a portion of the carbonated materials 6, which is then directly sent into the burning zone of the indirect calciner 84, via a sealing device (i.e. selective separation means) 21.

The reactor 8 in FIG. 21 is an indirect calciner 84, whose exhaust gas is fed into the third circuit 12″ via an exhaust passage 100. The exhaust passage 100 is connected downstream from the cooling section 22″ of the third circuit 12′. The mix of heated air from the cooling section 22″ and combustion gas is then used to preheat carbonated materials 6. The preheated carbonated materials 6 are then sent to the calcination zone (reactor 84) of the first circuit 2.

Furthermore, FIG. 21 shows an intake passage 110 for transferring at least a portion of the third gas 14′ to the burner. The intake passage 110 is connected downstream from the cooling section 22 of the third circuit 12′. Alternatively, the air for the burner can be heated via a heat exchanger exchanging heat from the second circuit 12 and the air for the burner (not shown). This way of reclaiming energy is a further possibility for minimizing specific energy input.

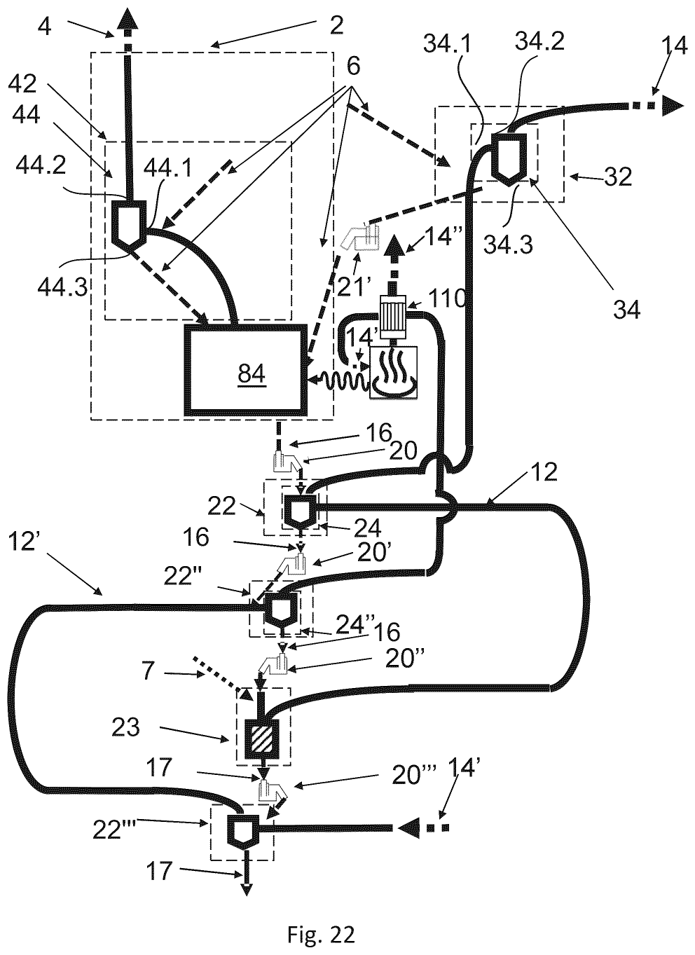

The embodiment according to FIG. 22 differs from that in FIG. 21 in that the second gas 14 and not the third gas 14′ accomplishes the preheating of a portion of the carbonated materials 6, which is then directly sent into the burning zone of the indirect calciner 84.

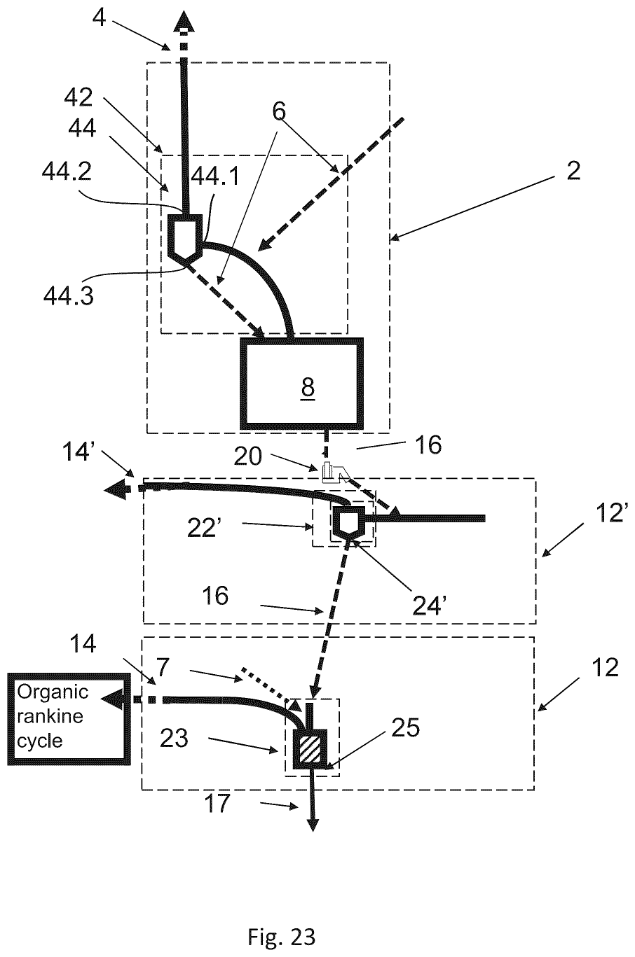

In the embodiment shown in FIG. 23, the decarbonated particles 16 are cooled down in a cooling section (22″) of the third circuit (12′) before being transferred to the hydration section (23) of the second section (12). The embodiment of FIG. 23 differs from the embodiment in FIG. 3 to the extent that the decarbonated particles 16 exiting the first circuit 2 at a temperature of typically above 900° C. are cooled by a gas stream that is not involved in the hydration. The hydration heat is recovered for the generation of electricity in a low temperature organic rankine cycle. Preferably, the modelized operating conditions for this embodiment are the following
Pressure in hydrating section 23 is (about) atmospheric pressure;
Decarbonated material 16 consist in quicklime CaO and is fed in hydrating section at (about) 450° C.;
Liquid water 7 is fed in hydrating section at (about) 20° C.;
Water/quicklime stoichiometric ratio is fixed at 2.1 mol/mol or equally 0.675 kg of water per kg of quicklime;
Hydration reaction enthalpy is (about) 1.1 MJ/kg of quicklime (exothermal);
Temperature of Ca(OH)₂ product and excess water after completion of hydration reaction is (about) 281° C.;
(About) 1.32 kg/kg (quicklime) of hydrated material Ca(OH)₂ 17 is produced and discharged from hydration reactor;
Excess water is vaporized resulting in a steam flow rate 14 of (about) 0.35 kg/kg (of quicklime) at (about) 281° C. corresponding to a thermal energy flow rate of (about) 1.03 MJ/kg of quicklime;
Low pressure steam flow 14 is used to run an organic rankine cycle turbine (about 15% energy efficiency) producing (about) 43 kWh of electricity per kg of quicklime.

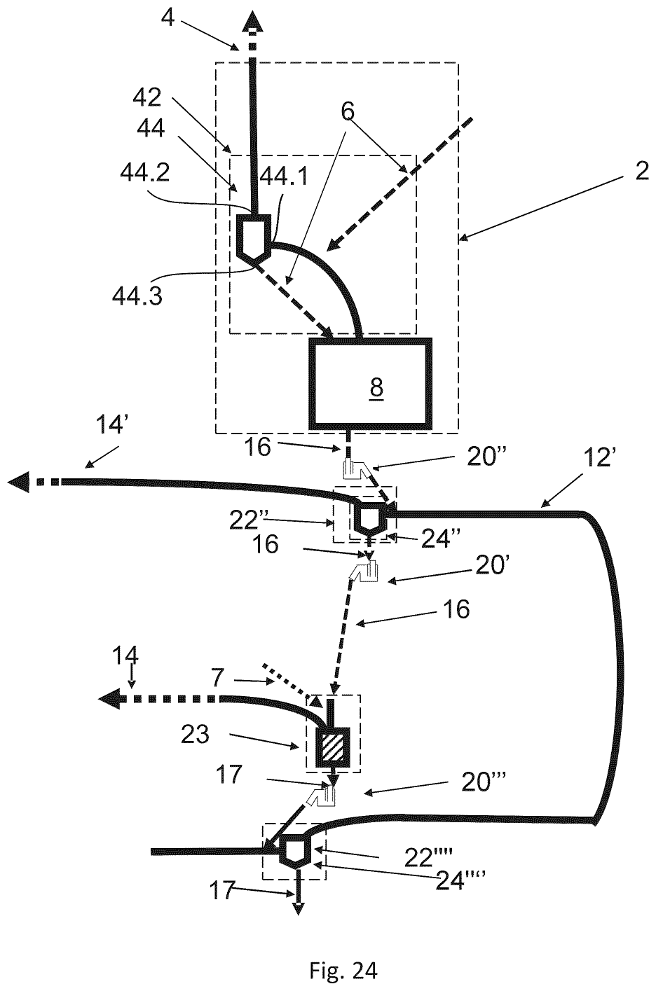

The embodiment in FIG. 24 differs from that of FIG. 23 in that the third circuit 12′ comprises a further cooling section 22″′ positioned upstream from said cooling section 22″, where the hydrated particles 17 are cooled. Even if the embodiment in FIG. 24 does not present a recovery unit, such means for recovery the heat energy can be provided.

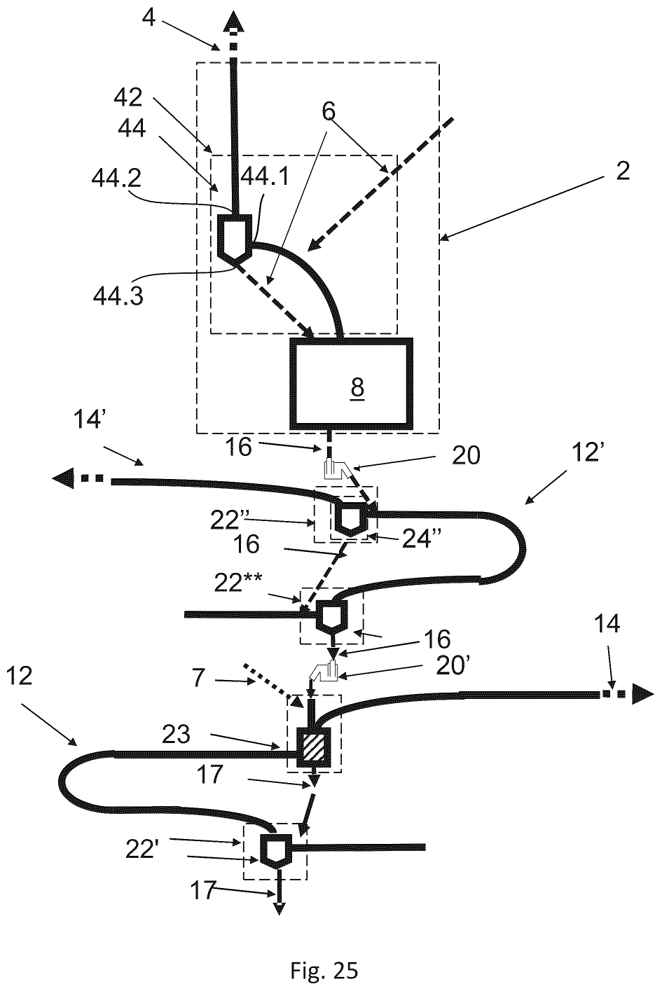

The embodiment in FIG. 25 differs from that of FIG. 23 in that the third circuit 12′ comprises an additional cooling section 22** positioned upstream from the cooling section 22″, where the carboned particles 16′ are further cooled before there are fed to the hydration section 23. Furthermore, the second circuit 12 comprises a further cooling section 22′ positioned upstream from the hydration section 23. Even if the embodiment in FIG. 25 does not present a recovery unit, such means for recovery the heat energy can be provided.

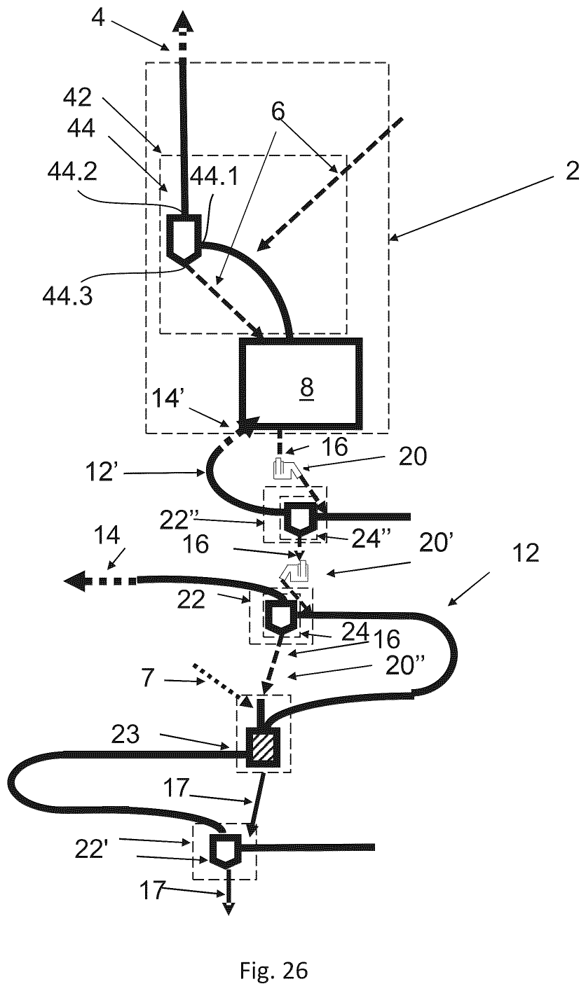

The embodiment in FIG. 26 differs from that of FIG. 23 in that the third circuit 12′ is fed with a combustion gas, for instance a dioxygen enriched composition. The dioxygen enriched composition is heated by the decarbonated particles 16 directly leaving the first circuit 2, transferred in the colling section 22″. Furthermore, the second circuit 12 comprises a cooling section 22 positioned downstream from said hydration and a further cooling section 22′ positioned upstream from the hydration section 23.

The present disclosure describes measures for managing two separate gas circuits 2, 12 and optionally a third one 12′: one for carbonated material transport, preheating and calcination, and another for product transport, product cooling and hydration and possibly carbonated materials transport and preheating. The calcination circuit gases will be relatively free of N₂ comprising mostly CO₂ and H₂O while the second 12 and third 12′ circuits will be relatively free of CO₂. Optionally, as a post-processing step, dust is removed from both or all circuit's gases. Furthermore, the H₂O can be removed from the calcination gases with, for example, an evaporative condenser resulting in a relatively pure stream of CO₂>85% dry vol. If required by the end use of this CO₂ stream, other treatment steps can be included in the calcination circuit for the removal of other contaminants such as trace amounts of O₂, N₂, and other residual gases.

Lime or hydrated lime can be used as sorbent for capturing CO₂ from a flue gas or air according to a process known as calcium looping. Any of the previous embodiments can be selected for producing such a sorbent. Lime carbonation being a solid-gas reaction, this reaction tends to occur firstly on the outer surface of lime particles. Carbonation to the core of the particles is slow due to the diffusion. Furthermore, Ca(OH)₂ sorbent is not optimal in regard to carbonation reaction enthalpy, as discussed in the following paragraph. Consequently, the hydration in the hydration section 23 can be performed as a partial hydration. In practice such a partial hydration could be more easily achieved in steam hydrator than liquid hydrator.

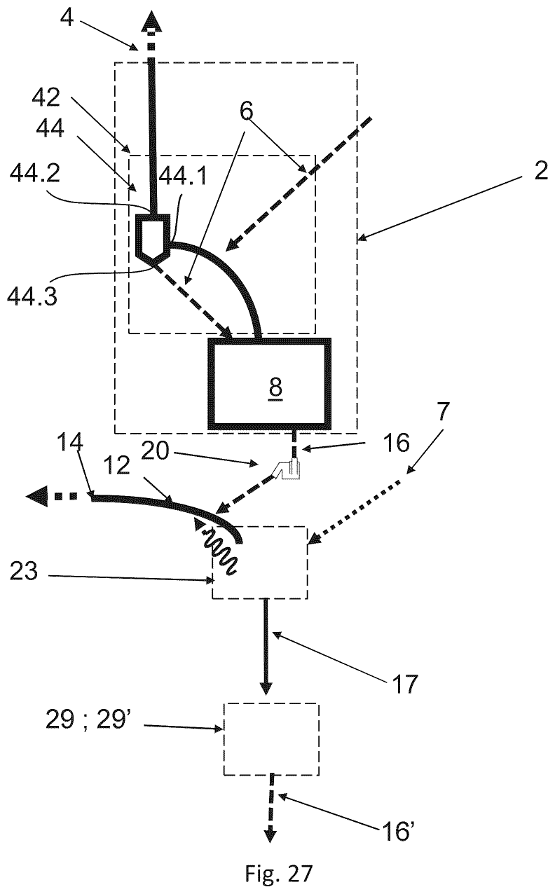

The embodiment in FIG. 27 is aimed to produce decarbonated materials 16′ (e.g. CaO) that will be used as a sorbent to be in contacted with CO₂-containing flue gas.

Due to its morphology, hydrated lime Ca(OH)₂ is more efficient than quicklime CaO at capturing CO2 (particle size in the range <100 μm, high surface area/porous volume). Indeed, the hydration process during which the hydrated lime is produced enhances the surface area/porosity of the product. However, quicklime has the advantages of releasing more energy than calcium hydroxide when undergoing carbonation reaction. This high reaction energy is useful for reaching high temperature that favours carbonation reaction.

The embodiment according to FIG. 27 comprises an intermediate step of forming hydrated particles 16 (e.g. hydrated lime) according to any of the embodiments shown in the previous figures. The embodiment in FIG. 27 does not show a third circuit 12′ for stake of simplicity, but such a circuit can be integrated. The hydrated particles 17 (e.g. hydrated lime) present an increased surface area/porous volume compared to the decarbonated particles 16 exiting the first circuit 2. In FIG. 27, the hydrated particles 17 formed in the hydration section 23 are fed to a dehydrating section 29, 29′ where the hydrated particles 17 (hydrated lime) are reconverted into (further) decarbonated particles 16′ (quicklime) keeping the high surface area/porous volume of the intermediate product, in particular hydrated lime 17. This measure allows to obtain a highly-reactive sorbent (e.g. morphology) which releases more energy when undergoing carbonation in contact with a CO₂ containing gas.

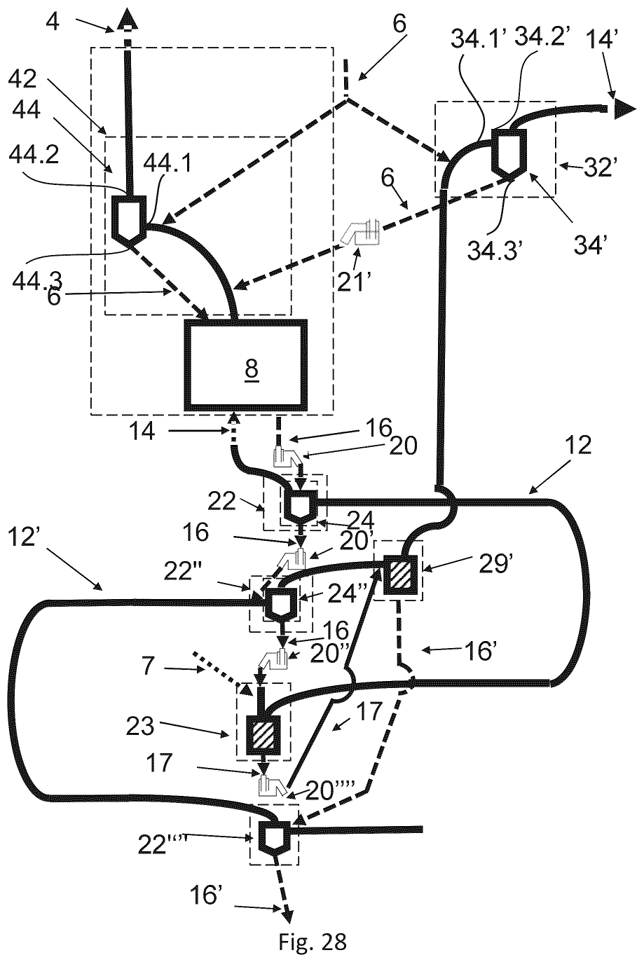

The embodiment according to FIG. 28 is a more specific embodiment of that of FIG. 27. The embodiment of FIG. 28 is based on that of FIG. 21 in which the burner supplied with the third gas 14′ is removed. Compared to FIG. 21, the hydrated particles 17 produced in the hydration section 23 are transferred to a dehydrating section 29′ arranged on the third circuit 12′. The hydrated particles 17 in the presence of heat (T>520° C. under P_{H2O}=(around) 1 bar) release H₂O forming (further) decarbonated particles 16. The (further) decarbonated particles 16 are then transferred to a complementary cooling section 22″″ in the third circuit 12′ arranged upstream from the cooling section 22″ of the third circuit 12′, in which the said (further) decarbonated particles 16′ release a portion of their thermal energy. The (further) decarbonated particles are then separated in the complementary cooling section 22″″.

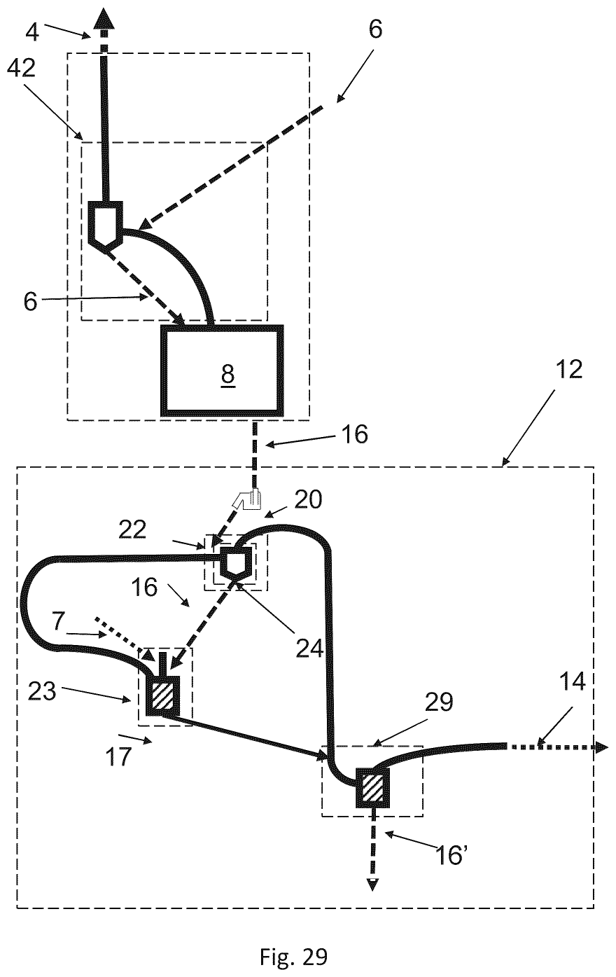

The embodiment according to FIG. 29 is another embodiment derived from FIG. 27. The embodiment of FIG. 29 differs from that of FIG. 3 in that the dehydrating section 29 is positioned downstream from the cooling section 20 of the second circuit 12. The hydrated particles 17 produced in the hydration section 23 are transferred to the dehydrating section 29, in which the hydrated particles 17 in the presence of heat (T>520° C. under P_{H2O}=(around) 1 bar) from the second gas 14 release H₂O forming decarbonated particles 16′.

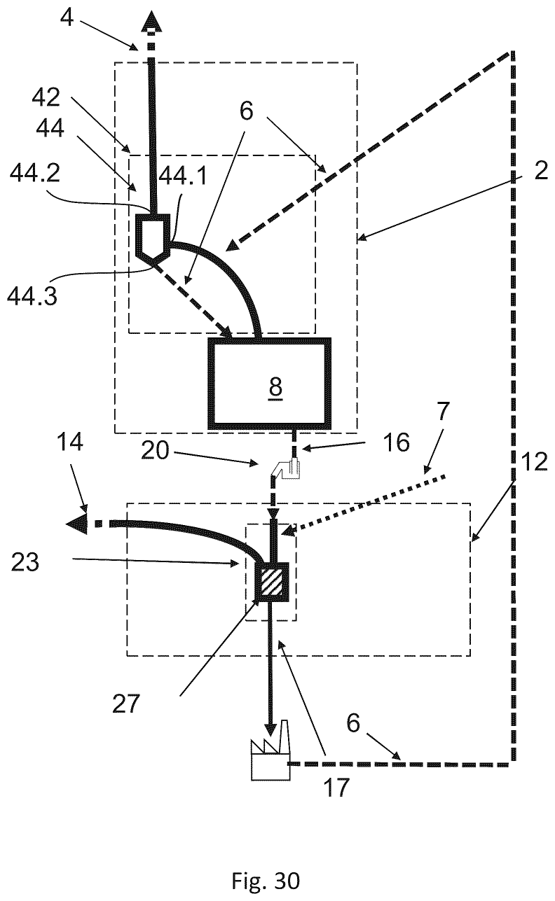

The embodiment in FIG. 30 illustrates a CO₂ capture process known as calcium looping in which a sorbent, namely hydrated materials/particles 17 (e.g. hydrated lime) is contacted with CO₂-containing gas and is then converted into carbonated materials/particles 6 (e.g. calcium carbonates). The embodiment in FIG. 30 does not show a third circuit 12′ for sake of simplicity, but such a circuit can be integrated. Typically, a CO₂-containing gas is for instance a flue gas or air, or mixture thereof. The carbonated materials/particles 6 (e.g. calcium carbonate) are then sent to a calciner (i.e. the first circuit 2) and subsequently to the hydration section 23, in order to regenerate the sorbent, namely hydrated materials/particles 17 (e.g. hydrated lime) while at the same time producing a concentrated stream of CO₂. The calcium looping process can also be used to capture CO₂ from the atmosphere for subsequent sequestration.

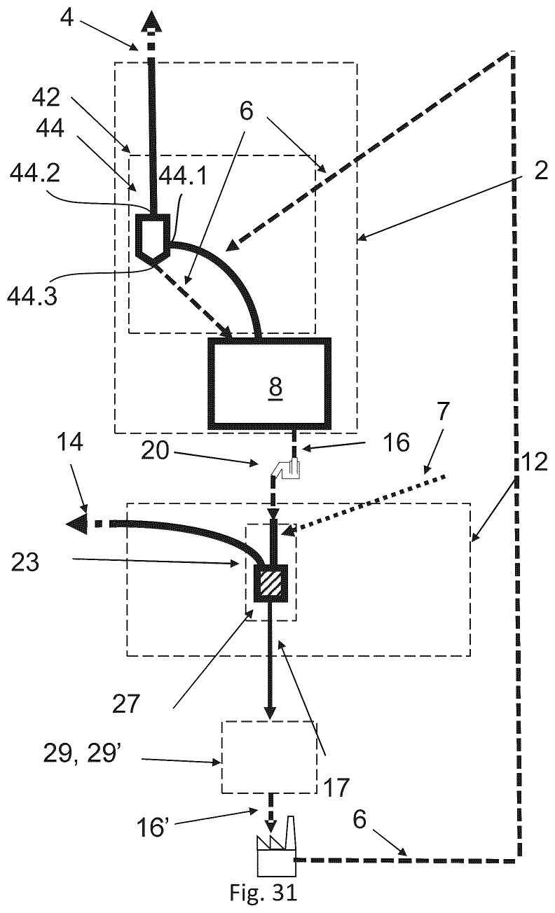

The embodiment in FIG. 31 illustrates an alternative calcium looping process in which a sorbent, namely decarbonated materials/particles (e.g. quick lime) is contacted with CO₂-containing gas and is then converted in carbonated materials/particles 6 (e.g. calcium carbonates). The embodiment in FIG. 31 does not show a third circuit 12′ for sake of simplicity, but such a circuit can be integrated. The formed carbonated materials/particles 6 (e.g. calcium carbonate) are then sent sequentially to a calciner (i.e. the first circuit 2) and a hydration section 23, and a dehydrating section 29, 29′ in order to regenerate the sorbent 16′, while at the same time producing a concentrated stream of CO₂.

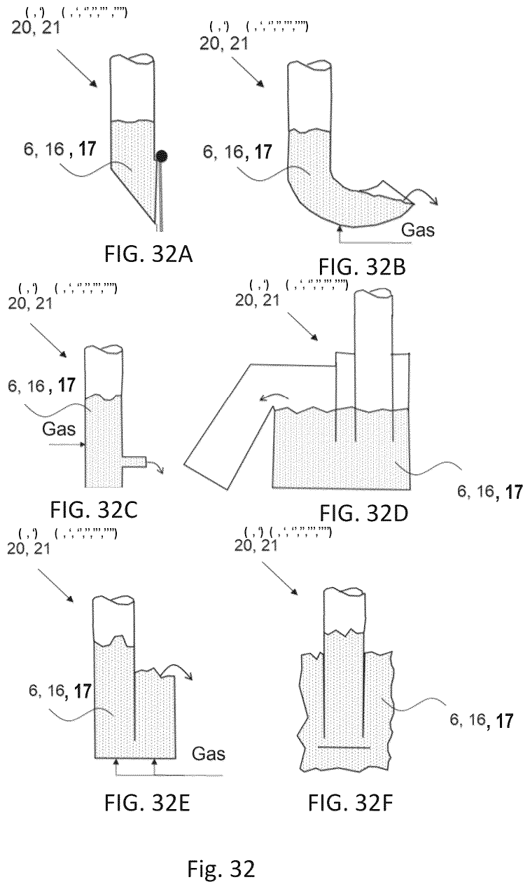

The selective separation means 20, 20, 20′, 20″, 20″′, 21, 21′ connecting the first 2 and second circuits 12, second 12 and third circuit 12′ or first and third circuit 12′ are arranged so as to allow the transfer of either the particles of carbonated materials 6, the decarbonated particles 16 or hydrated particles 17 of said materials between the respective circuits while substantially preventing the passage of gases thereof. The selective separation means 20, 20, 20′, 20″, 20″′, 21, 21′ is in particular a siphon element, a loop seal (see FIG. 32D), single or multiple flaps, table feeder, cellular wheel sluice, fluid seal-pot (see FIG. 32E), “Dollar” plate (see FIG. 32F), or any of the following valves: rotary valves, cone valve, J valve (see FIG. 32B), L valve (see FIG. 32C), trickle valve (see FIG. 32A) and flapper valve.

Since the interfaces between the calcination (first circuit 2) and the second circuit 12 are very hot, this invention prioritizes the utilization of a non-mechanical sealing device (selective separation means 20, 21) with no moving part, such as a siphon element, a loop seal (see FIG. 32D), fluid seal-pot (see FIG. 32E), “Dollar” plate (see FIG. 32F), cone valve, J valve (see FIG. 32B) or L valve (see FIG. 32C). When a fluidising or aeration gas is needed to help the solid movement in the non-mechanical sealing device, steam is a preferred option as aeration gas. Alternatively, hydration is thermodynamically possible in the sealing device air, or O₂ can be used for such aeration purposes. In this way of separation, the fine carbonated material 6, intermediated 16, 17 or final product 16 or 17 provides a plugged seal keeping the gas streams reliably separated while preferring to avoid the use of a less reliable mechanical device in such very hot conditions. Pressure in the two circuits 2, 12, and optionally in the third circuit 12′ in the vicinity of the sealing devices can be equalized by adding a tail fan (if necessary) to the second 12 and/or third 12′ circuit and/or by creating pressure drop with a throttle valve (e.g. louver, damper) in the calcination circuit to minimize the Ap across the seal. This helps to avoid CO₂ leaking into the second circuit 12 or N₂ leaking into the calcination circuit 2.

By limestone, dolomite or other carbonated materials (also known as carbonate materials) is meant materials fitting the formula:
aCaCO₃·bMgCO₃·cCaMg(CO₃)₂·xCaO·yMgO·zCa(OH)₂·tMg(OH)₂·ul, wherein I are impurities; x, y, z, t and u each being mass fractions ≥0 and ≤90%, a, b and c each being mass fractions ≥0 and ≤100%, with a+b+c≥10% by weight, based on the total weight of said materials, preferably x, y, z, t and u each being mass fractions ≥0 and ≤50%, a, b and c each being mass fractions ≥0 and ≤100%, with a+b+c≥50% by weight, based on the total weight of said materials; preferably the particles of the carbonated minerals having a d90 less than 10 mm, preferably less than 6 mm, more preferably less than 4 mm.

By decarbonated materials is meant materials fitting the formula aCaCO₃·bMgCO₃·cCaMg(CO₃)₂·xCaO·yMgO·zCa(OH)₂·tMg(OH)₂·ul,
wherein I are impurities; a, b, c, z, t and u each being mass fractions ≥0 and ≤50%, x and y each being mass fractions ≥0 and ≤100%, with x+y≥50% by weight, based on the total weight of said materials;

By hydrated materials is meant materials fitting the formula aCaCO₃·bMgCO₃·cCaMg(CO₃)₂·xCaO·yMgO·zCa(OH)₂·tMg(OH)₂·ul,
wherein I are impurities; a, b, c, and u each being mass fractions ≥0 and ≤50%, z and t each being mass fractions ≥0 and ≤100%, with z+t≥10% by weight, preferably z+t≥50% by weight, x and y each being mass fractions ≥0 and ≤100%, with x+y≤90% by weight, based on the total weight of said materials;

By “gas composition being substantially free of nitrogen” is meant that the amount of nitrogen represents less than 10% vol., more preferably less than 5%, in particular less than 1% in volume (i.e. vol.) of the this gas composition.

By “substantially free of carbon dioxide” we understand that the amount of carbon dioxide represents less than 10% vol., more preferably less than 5%, in particular less than 1% in volume (i.e. vol.) of the this gas composition.

By “a dioxygen enriched composition” we understand that the amount of O₂ represents at least 70% vol. of the this gas composition.

By “pure dioxygen” we understand that the amount of O₂ represents at least 90% vol. of the this gas composition.

The calcination in the reactor 8, 82, in particular the externally-fired calciner 84 can be a flash calcination.

The heat released in the condenser 50 (e.g. see embodiments according to FIG. 16, 17, 18) can be reused, for instance to heat the carbonated materials 6 before they are fed to the first circuit 2 (this option is not shown).

Embodiments as discussed above are defined by the following numbered clauses:

1. Process for decarbonation of limestone, dolomite or other carbonated materials and hydration of said decarbonated limestone, dolomite or other carbonated materials, said process comprising the following steps:
heating particles of carbonated materials (6) in a reactor (8) of a first circuit (2) up to a temperature range in which carbon dioxide of the carbonated materials is released to obtain decarbonated particles (16) comprising CaO and/or MgO;
optionally conveying said particles of carbonated materials (6) by a first entraining gas (4) in the first circuit (2) for preheating said carbonated materials (6), said gas (4) comprising the released carbon dioxide, said gas composition being substantially free of nitrogen;
optionally separating, in particular inertially separating, the carbonated particles (6) from a first entraining gas (4) flow;
transferring the decarbonated particles (16) to a second circuit (12), in which a second gas (14), circulates, said circuit (12) comprising a hydration section (23);
cooling the decarbonated particles (16) in a cooling section (22) of the second circuit (12), in which the decarbonated particles (16) release a portion of their thermal energy, thereby heating the second gas (14) and ensuring a cooling of said decarbonated particles (16);
hydrating the decarbonated particles (16) in contact with water (7) as liquid and/or steam, and optionally in the presence of a dilution gas, such as air or a dioxygen enriched composition, in particular pure dioxygen, in the hydration section (23) to obtain hydrated particles (17) comprising Ca(OH)₂ and/or Mg(OH)₂;
transferring at least a portion of the heat generated by the hydration of the decarbonated particles (16) to the second gas (14);
wherein the first (2) and second circuits (12) are separated by a first selective separation means (20) allowing the passage of solids while substantially preventing the passage of the gases (4, 14), wherein said second gas (14) is substantially free of carbon dioxide.

2. Process according to Clause 1, wherein the cooling section (22) of the second circuit (12) is positioned downstream from the hydration section (23), further comprising before the hydration step:
separating, in particular inertially separating, the decarbonated particles (16) conveyed by a second gas (14) flow in the cooling section (22);
transferring the separated decarbonated particles (16) from the cooling section (22) to the hydration section (23).

3. Process according to any of the previous clauses, wherein a portion of the heat generated by at least the hydration of the decarbonated particles (16), the sensible heat of the decarbonated particles (16) and/or the sensible heat of the hydrated particles (17), are transferred to a third gas (14′) substantially free of carbon dioxide circulating in a third circuit (12′), in particular via a heat exchanger and/or via contacting the hydrated particles (17) and/or decarbonated particles (16) with the third gas (14′), respectively.

4. Process according to Clause 2 in combination with Clause 3, wherein the transferring the separated decarbonated particles (16) from the cooling section (22) to the hydration section (23) comprises the steps of:
transferring the decarbonated particles (16) separated to a cooling section (22″) of the third circuit (12′) comprising the third gas (14′) in which the conveyed decarbonated particles (16) release a portion of their thermal energy, in particular via a first selective separation means (20′) arranged between the second (12) and third circuits (12′), said separation means (20′) allowing the passage of solids while substantially preventing the passage of the gases (14, 14′).
separating the decarbonated particles (16) from a third gas (14′) flow;
transferring the decarbonated particles (16) separated from the third gas (14′) flow to the hydration section (23), in particular via a second selective separation means (20″) arranged between the second (12) and third circuits (12′), said separation means (20″) allowing the passage of solids while substantially preventing the passage of the gases (14, 14′).

5. Process according to the previous clause, further comprising the steps of:
transferring the hydrated particles (17) to a further cooling section (22″′) of the third circuit (12′) in which the hydrated particles (17) release a portion of their thermal energy, preferably via a third selective separation means (20″′) arranged between the second (12) and third circuits (12′), said separation means (20″′) allowing the passage of solids while substantially preventing the passage of the gases (14, 14′);
separating the hydrated particles (17) cooled in the previous step from the third gas (14′) flow, wherein the further cooling section (22″′) is arranged upstream from the cooling section (22″) of the third circuit (12′).

6. Process according to Clause 4, comprising transferring the hydrated particles (17) to a further cooling section (22′) of the second circuit (12) upstream from the hydration section (23), in which the conveyed hydrated particles (17) release a portion of their thermal energy, thereby heating the second gas (14) flow.

7. Process according to any of the previous clauses, further comprising the steps of
Feeding the hydration section (23) with
   the decarbonated particles (16),
   liquid water and/or water steam, and
   optionally the diluting gas;
Extracting a gas comprising hot air, water steam, fuel, or a dioxygen enriched composition, or any mixture thereof from said hydration section (23), said gas comprising at least a portion of the heat generated by the hydration of the decarbonated particles (16);
Supplying the second circuit (12) with said gas.

8. Process according to any of the previous clauses, wherein the step of transferring at least a portion of the heat generated by the hydration of the decarbonated particles (16) to the second gas (14) comprises transferring at least a portion of the heat generated by the hydration of the decarbonated particles (16) to the second gas (14) via at least one heat exchanger.

9. Process according to any of the previous clauses, wherein the hydration section (23) comprises a fluidized bed reactor (25) such as a circulating fluidized bed, an entrained bed or a bubbling bed or a slaker such as a paddle mixer (25′).

10. Process according to any of the preceding clauses, further comprising the step of introducing the particles of carbonated materials (6) in a heating section (32) of the second circuit (12), in which the heating section (32) is positioned downstream of the hydration section (23), so that the heat extracted from the hydration section (23), the decarbonated particles (16), and optionally the hydrated particles (17), in particular to the second gas (14), is used to heat the particles of carbonated materials (6) by means of a solid-gas heat exchange (34), the heated carbonated particles (6) being subsequently separated from the second gas flow (14) and transferred to the reactor (8) or upstream of a pre-heating section (42) of the first circuit (2), preferably via a second selective separation means (21) arranged between the first (2) circuit and the second (12) circuit, allowing the passage of solids while substantially preventing the passage of the gases (4, 14).

11. Process according to any of clauses 3 to 5 in combination with any of clauses 1 to 2 or 6 to 10, further comprising the step of introducing the particles of carbonated materials (6) in a heating section (32′) of the third circuit (12′), in which the heating section (32′) is positioned downstream of the cooling section (22″), so that heat extracted from the decarbonated particles (16) and optionally the hydrated particles (17) and/or heat extracted from the hydration section (23), in particular to the third gas (14′), is used to heat the particles of carbonated materials (6) by means of a solid-gas heat exchange (34′), the heated carbonated particles (6) being subsequently separated from the third gas (14′) flow and transferred to the reactor (8) or upstream of the pre-heating section (42) of the first circuit (2), preferably via a selective separation means (21′) arranged between the first (2) circuit and the third (12′) circuit, allowing the passage of solids while substantially preventing the passage of the gases (4,14′).

12. Process according to any of the previous clauses, further comprising maintaining pressure in at least the hydration section (23), the cooling section (22) and/or the further cooling section (22′) of the second circuit (12) above the atmospheric pressure between 1 and 20 bars above atmospheric pressure, and/or the temperature in at least the hydration section (23), the cooling section (22) and/or the further cooling section (22′) of the second circuit (12) below the temperature at which de-hydration occurs such as T[°K]<11607/(14,6484−ln (P_{H2O}[bar])).

13. Process according to any of the previous clauses, further comprising the step of feeding the second circuit (12) with air and/or an dioxygen enriched composition, in particular pure dioxygen, and optionally fuel.

14. Process according to any of the previous clauses, further comprising the step of feeding the third circuit (12) with air and/or an dioxygen enriched composition, in particular pure dioxygen, and optionally fuel.

15. Process according to any of Clauses 1 to 12, further comprising the step of discharging the second gas (14) and/or third (14′) gas in the atmosphere, at an outlet of the second (12) and/or third (12′) circuit, respectively.

16. Process according to any of the previous clauses, further comprising the step of feeding the reactor (8) with the second (14) and/or third (14′) gas.

17. Process according to any of the previous clauses, further comprising supplying with the second (14) and/or third gas (14′) at least one heat recovery element in which the heat of the second (14) and/or third gas (14′) is used for:
preheating and drying at least carbonated material, in particular the carbonated particles (6) and/or fuel;
drying hydrated product, in particular the hydrated particles (17);
providing heat source for a gas treatment process, in particular an amine gas treating apparatus, a thermal swing adsorption apparatus, a cryogenic refrigeration apparatus, a CO2 conversion reaction;
generating mechanical work; and/or
generating electricity.

18. Process according to any of the previous clauses, further comprising the step of introducing the particles of carbonated materials (6) in the pre-heating section (42) of the first circuit (2) so that said particles are pre-heated by the first entraining gas (4) by means of a solid-gas heat exchange (44).

19. Process according to any of the previous clauses, further comprising the step of recirculating at least a portion of the carbon dioxide released in the reactor (8) in the first circuit (2), preferably recirculating said carbon dioxide to the reactor (8).

20. Process according to any of the previous clauses, further comprising the step of recycling at least a portion of the heat of the second (14) gas, preferably exchanging heat from the second (14) to the first entraining gas (4), more preferably through a gas-gas heat exchanger (60) positioned between the first circuit (2) and the second (12) circuit.

21. Process according to any of Clauses 3 to 5 in combination with any of Clauses 1 to 2 or 6 to 20, further comprising the step of recycling at least a portion of the heat of the third gas (14′), preferably exchanging heat from the third (14′) gas to the first entraining gas (4), more preferably through a gas-gas heat exchanger (60) positioned between the first circuit (2) and third (12′) circuit.

22. Process according to any of the previous clauses, wherein at least one of the separation means (20, 20′, 20″, 20″′, 21, 21′) allowing the passage of solids (6, 16, 17) while substantially preventing the passage of the gases (4, 14, 14′) comprises a siphon element, a loop seal, single or multiple flaps, table feeder, cellular wheel sluice, fluid seal-pot, “Dollar” plate, or any of the following valves: rotary valves, cone valve, J valve, L valve, trickle valve and flapper valve.

23. Process according to any of the previous clauses, further comprising the steps of:
transferring the hydrated particles (17) from the hydration section (23) to a slaked lime dryer;
drying the hydrated particles (17) in the slaked lime dryer using a portion of the thermal energy of the second fluid (14) flow.

24. Process according to any of the previous clauses, further comprising the step of separating at least one constituent, in particular water, from at least one portion of the first gas (4) exiting the reactor (8), preferably transferring said water to the hydration section (23).

25. Process according to any of the previous clauses, wherein the reactor (8) is a first reactor (8, 82, 84), said process further comprising the step of extending decarbonation degree and/or adjusting the product reactivity, preferably extending the retention time of the decarbonated particles (16) in a second reactor (86).

26. Process according to any of the previous clauses, further comprising the step of burning at least a portion of the second (14) or third (14′) gas (14′), in a in a burner outside the reactor (8), said reactor (8) comprising the externally-fired calciner (84).

27. Process according to any of the previous clauses, wherein the particles of the carbonated (6) minerals have a d90 less than 10 mm, preferably less than 6 mm, more preferably less than 4 mm.

28. Process according to any of the previous clauses, wherein the carbon dioxide represents at least 50%, preferably at least 85% by volume of the first entraining dry gas composition exiting the reactor (8).

29. Process according to any of the previous clauses, further comprising the step of controlling a louver or a damper and/or a fan speed in at least the first circuit (2), second circuit (12) and/or third circuit (12′) so that the absolute pressure difference across at least one of the selective separation means (20, 20′, 22″, 22″, 22″′, 21, 21′) remains below a predefined value, preferably remains within a given pressure range.

30. Process for decarbonation of limestone, dolomite or other carbonated materials comprising steps of
producing hydrated particles (17) using the process for decarbonation of limestone, dolomite or other carbonated materials and hydration of said decarbonated limestone, dolomite or other carbonated materials according to any of the previous clauses;
transferring the hydrated particles (17) to a dehydrating section (29, 29′);
dehydrating the hydrated particles (17) in the dehydrating section (29, 29′) in which the hydrated particles (17) are exposed to a temperature range and pressure range in which the H₂O is released forming further decarbonated particles (16′) comprising CaO and/or MgO.

31. Process according to the previous clause, wherein the dehydrating section (29′) is provided in the third circuit (12′) downstream from the cooling section (22″) thereof, said process comprising transferring the hydrated particles (17) from the hydration section (19′) to the dehydrating section (29′), optionally via a fourth selective separation means (20″″) arranged between the second (12) and third circuits (12′) allowing the passage of solids, while substantially preventing the passage of the gases (14, 14′), said process further comprising the step of discharging the further decarbonated particles (16′) formed in the dehydrating section (29′).

32. Process according to the previous clause, further comprising the steps of:
transferring the further decarbonated particles (16′) discharged to a complementary cooling section (22″″) in the third circuit in which the further decarbonated particles (16′) release a portion of their thermal energy;
separating the further decarbonated particles (16′) cooled in the previous step from the third gas (14′) flow, wherein the complementary cooling section (22″″) is arranged upstream from the cooling section (22″) of the third circuit (12′).

33. Process according to Clause 30, wherein the dehydrating section (29) is provided in the second circuit (12′) downstream from the cooling section (22) thereof, said process further comprising the step of:
separating the further decarbonated particles (16′) formed in the dehydrating section (29) from the second gas (14) flow.

34. Process for capturing CO₂ from air or flue gas comprising the following steps:
a. producing hydrated materials using a process for decarbonation of limestone, dolomite or other carbonated materials and hydration of said decarbonated limestone, dolomite or other carbonated materials according to any of Clauses 1 to 29;
b. contacting the produced lime hydrate materials with CO2-containing gas stream such as air or flue gas so as to remove CO2 from said gas stream, respectively;
c. recycling the carbonated materials formed in step b) as carbonated materials for step a).

35. Process for capturing CO₂ from air or flue gas comprising the following steps:
a. producing decarbonated materials using the process for decarbonation of limestone, dolomite or other carbonated materials according to any of Clauses 30 to 33;
b. contacting the produced decarbonated materials with air or flue gas so as to remove CO₂ from air or flue gas, respectively;
c. recycling the carbonated materials formed in step b) as carbonated materials for step a).

36. Device for the decarbonation of limestone, dolomite or other carbonated materials and hydration of said decarbonated limestone, dolomite or other carbonated materials, for carrying out the process according to any of the preceding Clauses 1 to 29 comprising:
a first circuit (2) in which a first entraining gas (4) substantially free of nitrogen conveys particles (6) of said carbonated mineral, said first circuit comprising a reactor (8) in which said particles (6) are heated to a temperature range in which carbon dioxide is released to obtain decarbonated particles comprising CaO and/or MgO;
a second circuit (12) in which a second gas (14) substantially free of carbon dioxide is circulated, the second circuit (12) comprising a cooling section (22) for cooling the decarbonated particles (16) and a hydration section (23) in which the decarbonated particles (16) transferred from the first circuit (2) are in contact with water (7) as liquid and/or steam and optionally a diluting gas;
at least one selective separation means (20, 21) connecting the first (2) and second circuits (12) arranged so as to allow the transfer of either the particles of carbonated materials or the decarbonated particles (16) of said materials between the first circuit and the second circuit while substantially preventing the passage of gases (4, 14), in particular a siphon element, a loop seal, single or multiple flaps, table feeder, cellular wheel sluice, fluid seal-pot, “Dollar” plate, or any of the following valves: rotary valves, cone valve, J valve, L valve, trickle valve and flapper valve.

37. Device according to Clause 36, wherein the cooling section (22) of the second circuit is positioned downstream from the hydration section (23) of the second circuit (2) and optionally the second circuit (12) comprising a further cooling section upstream from the hydration section (23), preferably the cooling section (22) and optionally the further cooling section comprising a solid/gas suspension heat exchanger (24, 24′), respectively.

38. Device according to Clause 36 or 37, wherein a first selective separation means (20) connecting the first (2) and the second circuit (12) allowing the transfer of the decarbonated particles (16) from the first circuit (2) to the second circuit (12) while substantially preventing the passage of gases (4, 14), the first selective separation means (20) being connected upstream of an inlet (24.1) of the suspension heat exchanger (24) of the cooling section (22) of the second circuit (12).

39. Device according to any of Clauses 36 to 38, wherein the hydrating section (23) comprises a fluidized bed reactor (25) such as a circulating fluidized bed, an entrained bed or a bubbling bed or a slaker such as a paddle mixer (25′).

40. Device according to any of Clauses 36 to 39, further comprising a third circuit (12′) in which a third gas (14′) substantially free of carbon dioxide is circulated, said circuit comprising a cooling section (22″) in which the decarbonated particles (16) transferred from the second circuit (12) release a portion of their thermal energy to the third gas (14′), preferably said cooling section (22″) comprising a solid/gas suspension heat exchanger (24″).

41. Device according to the previous clause, wherein a first selective separation means (20′) connecting the second (12′) and the third circuit (12″″) allowing the transfer of the decarbonated particles (16) between the second circuit (12′) and the third circuit (12″) while substantially preventing the passage of gases (14′, 14″), preferably the first selective separation means (20′) being connected to a return passage (24.3) for collecting the separated decarbonated particles (16) of the suspension heat exchanger (24) of the cooling section (22) of the second circuit (12) and upstream of an inlet (24.1″) of the suspension heat exchanger (24″) of the cooling section (22″) of the third circuit (12′).

42. Device according to the previous clause, wherein the third circuit (12′) comprises a further cooling section (22″′) positioned upstream from the cooling section (22″) of the third circuit (12′), preferably said further cooling section (22″′) comprising a solid/gas suspension heat exchanger (24″′).

43. Device according to the previous clause, wherein a second selective separation means (20″) connecting the third (12′) and the second circuit (12) allowing the transfer of the decarbonated particles (16) from the third circuit (12′) to the second circuit (12) while substantially preventing the passage of gases (14, 14′), preferably the second selective separation means (20″) being connected to a return passage (24.3″) for collecting the separated decarbonated particles (16) of the suspension heat exchanger (24″) of the cooling section of the third circuit (14′) and to an inlet of the hydration section (23).

44. Device according to the previous clause, wherein a third selective separation means (20″′) connecting the second (12) and the third circuit (12′) allowing the transfer of the hydrated particles (17) from the second circuit (12) to the third circuit (12′) while substantially preventing the passage of gases (14, 14′), preferably the third selective separation means (20″′) being connected to an outlet of the hydration section (23) and upstream of an inlet (24.1″′) of the suspension heat exchanger (24″′) of the further cooling section (22″′) of the third circuit (14′).

45. Device according to any of Clauses 36 to 44, wherein the first circuit (2) comprises a pre-heating section (42), said pre-heating section comprising a solid/gas suspension heat exchanger (44).

46. Device according to any of Clauses 36 to 45, wherein the second circuit (12) comprises a heating section (32) positioned downstream from the cooling section (22) of the second circuit (12), preferably said heating section (32) comprising a solid/gas suspension heat exchanger (34).

47. Device according to the previous clause, wherein a second selective separation means (21) connecting the first (2) and the second circuit (12) allowing the transfer of the carbonated particles (6) from the second circuit (12) to the first circuit (2) while substantially preventing the passage of gases (4, 14), preferably the second selective separation means (21) being connected to a return passage (34.3) for collecting the separated carbonated particles (6) of the solid/gas suspension heat exchanger (34) of the heating section (32) of the second circuit (12) and to the reactor (8) or upstream of the solid/gas suspension heat exchanger (44) of the pre-heating section (32) of the first circuit (2).

48. Device according to any of Clauses 40 to 44 in combination with any of Clauses 45 to 47, wherein the third circuit (12′) comprises a heating section (32′) positioned downstream from the cooling section (22″) of the third circuit (12′), preferably said heating section (32′) comprising a solid/gas suspension heat exchanger (34′).

49. Device according to the previous clause, wherein a second selective separation means (21′) connecting the first (2) and the third circuit (12′) allowing the transfer of the carbonated particles (6) from the third circuit (12′) to the first circuit (2) while substantially preventing the passage of gases (4, 14′), preferably the second selective separation means (21′) being connected to a return passage (34.3′) for collecting the separated carbonated particles (6) of the solid/gas suspension heat exchanger (34′) of the third circuit (12′) and to the reactor (8) or upstream of the solid/gas suspension heat exchanger (44) of the pre-heating section (32) of the first circuit (2).

50. Device according to any of Clauses 36 to 49, wherein the reactor (8) comprises an externally-fired calciner (84), said externally-fired calciner (84) comprising an exhaust passage (100), said passage (100) being connected to the second circuit (12), preferably upstream of the heating section (32).

51. Device according to any of Clauses 36 to 50, wherein the solid/gas suspension heat exchanger (44) of the first circuit (2) comprises at least one inertial separator, in particular a cyclone.

52. Device according to any of Clauses 36 to 51, wherein the solid/gas suspension heat exchangers (24, 24′, 24″) of the second (12) and third (12′) circuit and/or the solid/gas suspension exchanger (34; 34′) of the heating section (32) of the second (12) and third (12′) circuit each comprise at least one inertial separator, preferably a cyclone.

53. Device according to any of Clauses 36 to 52, comprising a condenser (50) to separate at least one constituent, in particular water from the first gas (4), said condenser (50) being positioned in the first circuit (2) downstream of the reactor (8).

54. Device according to any of Clauses 36 to 53, wherein the first circuit (2) comprises a recycling passage (90) for recycling at least a portion of the first gas (4) from a position downstream from the pre-heating section (32) or the condenser (50) to a position upstream of the reactor (8).

55. Device according to any of Clauses 36 to 54, wherein the second circuit (12) and/or third circuit comprise a heat-recovery element (60), preferably said heat-recovery element being configured to exchange the heat accumulated in the second (14) and/or third (14′) gas to the first gas (4) at a section of the first circuit (2), more preferably said heat-recovery system (60) being a heat exchanger (60) positioned between the first (2) circuit and the second (12) or third (12′) circuit.

56. Device according to any of Clauses 36 to 55, wherein the reactor (8) comprises at least one of the following elements: electric heater, oxy-burner, an indirect calciner such as solid heat-carrier reactor, an externally-fired calciner (84), or electrically-heated calciner, or a combination thereof.

57. Device according to any of Clauses 36 to 56, wherein the reactor (8) comprises a fluidized bed reactor, an entraining bed reactor, a circulated fluidized bed or any combination thereof.

58. Device according to the previous clause, wherein the externally-fired calciner (84) comprises an intake passage (110), said passage (110) being connected to the second circuit (12), preferably downstream from the heating section (32).

59. Device according to any of Clauses 36 to 58, wherein the second circuit (12) and/or third circuit comprise a further heat-recovery element, in particular in the list comprising: a fuel dryer, a hydrate dryer, a steam generator for generating mechanical work and/or electricity in a turbine, a CO2 treatment process such as an amine gas treating apparatus, a thermal swing adsorption apparatus or a cryogenic refrigeration apparatus.

60. Device for the decarbonation of limestone, dolomite or other carbonated materials, for carrying out the process according to any of Clauses 30 to 33, comprising a device for the decarbonation of limestone, dolomite or other carbonated materials and hydration of said decarbonated limestone, dolomite or other carbonated materials, according to any of Clauses 36 to 59, and a dehydrating section (29′, 29″).

61. Device according to the previous clause, wherein the dehydrating section (29) is positioned in the second circuit (12) downstream from the cooling section (22) of the second circuit (12), preferably said dehydrating section (29) comprising a solid/gas suspension heat exchanger.

62. Device according to Clause 60, wherein the dehydrating section (29′) is positioned in the third circuit (12′) downstream from the cooling section (22″) of the third circuit (12′), preferably said dehydrating section (29′) comprising a solid/gas suspension heat exchanger.

63. Device according to the previous clause, wherein a fourth selective separation means (20″″) connecting the second (12) and the third circuit (12′) allowing the transfer of the hydrated particles (17) from the second circuit (12) to the third circuit (12′) while substantially preventing the passage of gases (14, 14′), preferably the fourth selective separation means (20″″) being connected to an outlet passage of the hydration section (23) and an inlet of the dehydrating section (29′).

Although the present disclosure has been described and illustrated in details, it is understood that the same is by way of illustration and example only and is not to be taken by way of limitation, the scope of the present disclosure being limited only by the terms of the appended claims and/or clauses.

1. A process for decarbonation of limestone, dolomite or other carbonated materials and hydration of decarbonated limestone, dolomite or other carbonated materials, the process comprising:
heating particles of carbonated materials in a reactor of a first circuit up to a temperature range in which carbon dioxide of the carbonated materials is released to obtain decarbonated particles comprising either CaO, MgO, or both Cao and MgO;
conveying the particles of carbonated materials by a first entraining gas in the first circuit for preheating the carbonated materials, the first gas comprising the released carbon dioxide, a composition of the first gas being substantially free of nitrogen;
inertially separating the carbonated particles from a flow of the first entraining gas;
transferring the decarbonated particles to a second circuit, in which a second gas circulates, the second circuit comprising a hydration section;
cooling the decarbonated particles in a cooling section of the second circuit, in which the decarbonated particles heat the second gas by releasing a portion of a thermal energy of the decarbonated particles, such that the cooling of the decarbonated particles is ensured;
hydrating the decarbonated particles in contact with water as either liquid, steam, or both liquid and steam, in the hydration section to obtain hydrated particles comprising either Ca(OH)₂, Mg(OH)₂, or both Ca(OH)₂ and Mg(OH)₂; and
transferring at least a portion of heat generated by the hydration of the decarbonated particles to the second gas;
wherein the first and second circuits are separated by a first selective separation means configured to allow passage of solids while substantially preventing passage of the first and second gases, wherein the second gas is substantially free of carbon dioxide.

2. The process according to claim 1, wherein the cooling section of the second circuit is positioned downstream from the hydration section, the process further comprising, before hydrating the decarbonated particles:
separating the decarbonated particles conveyed by a flow of the second gas in the cooling section;
transferring the separated decarbonated particles from the cooling section to the hydration section.

3. The process according to claim 2, wherein a portion of the heat generated by one or more of the hydration of the decarbonated particles, the sensible heat of the decarbonated particles, or the sensible heat of the hydrated particles, are transferred to a third gas substantially free of carbon dioxide circulating in a third circuit.

4. The process according to claim 3, wherein transferring the separated decarbonated particles from the cooling section to the hydration section comprises:
transferring the separated decarbonated particles to a cooling section of the third circuit comprising the third gas in which a portion of a thermal energy of the conveyed decarbonated particles is released.
separating the decarbonated particles from a flow of the third gas;
transferring the decarbonated particles separated from the flow of the third gas to the hydration section.

5. The process according to claim 4, further comprising:
transferring the hydrated particles to a further cooling section in the third circuit in which a portion of a thermal energy of the hydrated particles is released to cool the hydrated particles;
separating the cooled hydrated particles from the flow of the third gas, wherein the further cooling section is arranged upstream from the cooling section of the third circuit.

6. The process according to claim 4, comprising transferring the hydrated particles to a further cooling section of the second circuit upstream from the hydration section, in which a portion of thermal energy of the conveyed hydrated particles is released to heat the flow of the second gas.

7. The process according to claim 1, further comprising:
feeding the hydration section with the decarbonated particles, and either liquid water, water steam, or both liquid water and water steam;
extracting a gas comprising one or more of hot air, water steam, fuel, or a dioxygen enriched composition, from the hydration section, the gas comprising at least a portion of the heat generated by the hydration of the decarbonated particles;
supplying the second circuit with the extracted gas.

8. The process according to claim 1, wherein the step of transferring at least a portion of the heat generated by the hydration of the decarbonated particles to the second gas comprises transferring at least a portion of the heat generated by the hydration of the decarbonated particles to the second gas via at least one heat exchanger.

9. The process according to claim 1, further comprising:
introducing the particles of carbonated materials in a heating section of the second circuit, in which the heating section is positioned downstream of the hydration section, such that the heat extracted from the hydration section and the decarbonated particles, is used to heat the particles of carbonated materials using a solid-gas heat exchange, the heated carbonated particles being subsequently separated from the second gas flow and transferred to the reactor or upstream of a pre-heating section of the first circuit.

10. The process according to claim 3, further comprising:
introducing the particles of carbonated materials in a heating section of the third circuit, in which the heating section is positioned downstream of the cooling section, such that heat extracted from one or both of the decarbonated particles or the hydration section, is used to heat the particles of carbonated materials using a solid-gas heat exchange, the heated carbonated particles being subsequently separated from the third gas flow and transferred to the reactor or upstream of the pre-heating section of the first circuit.

11. The process according to claim 1, further comprising feeding the second circuit with one or both of air or an dioxygen enriched composition.

12. The process according to claim 1, further comprising discharging the second gas in the atmosphere at an outlet of the second circuit.

13. The process according to claim 1, further comprising feeding the reactor with the second gas.

14. The process according to claim 1, further comprising supplying with the second gas at least one heat recovery element in which the heat of the second is used for one or more of:
preheating and drying at least carbonated material;
drying hydrated product;
providing heat source for a gas treatment process;
generating mechanical work; or
generating electricity.

15. A process for decarbonation of limestone, dolomite, or other carbonated materials, the process comprising:
heating particles of carbonated materials in a reactor of a first circuit up to a temperature range in which carbon dioxide of the carbonated materials is released to obtain decarbonated particles comprising either CaO, MgO, or both CaO and MgO;
conveying the particles of carbonated materials by a first entraining gas in the first circuit for preheating said carbonated materials, the first gas comprising the released carbon dioxide, a composition of the first gas being substantially free of nitrogen;
inertially separating the carbonated particles from a flow of the first entraining gas;
transferring the decarbonated particles to a second circuit, in which a second gas circulates, the circuit comprising a hydration section;
cooling the decarbonated particles in a cooling section of the second circuit, in which a portion of thermal energy of the decarbonated particles is released, heating the second gas and ensuring a cooling of the decarbonated particles;
hydrating the decarbonated particles in contact with water as either liquid, steam, or both liquid and steam, in the hydration section to obtain hydrated particles comprising either Ca(OH)₂, Mg(OH)₂, or both Ca(OH)₂ and Mg(OH)₂;
transferring at least a portion of the heat generated by the hydration of the decarbonated particles to the second gas; wherein the first and second circuits are separated by a first selective separation means allowing the passage of solids while substantially preventing the passage of the gases, wherein said second gas is substantially free of carbon dioxide.
transferring the hydrated particles to a dehydrating section;
dehydrating the hydrated particles in the dehydrating section in which the hydrated particles are exposed to a temperature range and pressure range in which the H₂O is released forming further decarbonated particles comprising either CaO, MgO, or both CaO and MgO.

16. A device for the decarbonation of limestone, dolomite, or other carbonated materials and hydration of decarbonated limestone, dolomite, or other carbonated materials, the device comprising:
a first circuit in which a first entraining gas substantially free of nitrogen conveys particles of the carbonated material, the first circuit comprising a reactor in which the particles are heated to a temperature range in which carbon dioxide is released to obtain decarbonated particles comprising either CaO, MgO, or both CaO and MgO;
a second circuit in which a second gas substantially free of carbon dioxide is circulated, the second circuit comprising a cooling section configured to cool the decarbonated particles and a hydration section in which the decarbonated particles transferred from the first circuit are in contact with water as either liquid, steam, or both liquid and steam;
at least one selective separation means connecting the first and second circuits arranged so as to allow the transfer of either the particles of carbonated materials or the decarbonated particles of the materials between the first circuit and the second circuit while substantially preventing the passage of gases, the at least one selective separation means being selected from the group consisting of a siphon element, a loop seal, single or multiple flaps, a table feeder, a cellular wheel sluice, a fluid seal-pot, a “Dollar”plate, a rotary valve, a cone valve, a J valve, an L valve, a trickle valve, and a flapper valve;
wherein the first circuit comprises a pre-heating section, the pre-heating section comprising a solid/gas suspension heat exchanger.

17. The device according to claim 16, wherein the cooling section of the second circuit is positioned downstream from the hydration section of the second circuit.

18. (canceled)

19. Device according to any of claim 16, wherein the hydrating section comprises a fluidized bed reactor or a slaker.

20-38. (canceled)

39. The process according to claim 1, wherein hydrating the decarbonated particles further comprises hydrating in the presence of one or more dilution gases selected from the group consisting of air, a dioxygen enriched composition, and pure dioxygen.

40. The device according to claim 16, wherein the hydration section comprises one or more of a circulating fluidized bed, an entrained bed, a bubbling bed, or a paddle mixer.
